(19) United States
(12) Patent Application Publication
(10) Pub. No.: US 2007/0198535 A1
(43) Pub. Date: Aug. 23, 2007

(54) Training system and method(s) of its use

(76) Inventors: Jeremy Oliver, Thornbury (AU); Luke Howie, Thornbury (AU)

Correspondence Address: LATIMER IP LAW, LLP, 13873 PARK CENTER ROAD, SUITE 122, HERNDON, VA, 20171, US

(21) Appl. No.: 11/663,348

(22) PCT Filed: Sep. 19, 2005
(86) PCT No.: PCT/AU05/01415

§ 371 Date: Mar. 21, 2007

(30) Foreign Application Priority Data
Sep. 21, 2004 (AU) 2004905425

(51) Int. Cl. G06F 17/30

(52) U.S. Cl. 707/10

(57) ABSTRACT

The present invention relates to the Exercise Industry. In one form, the invention relates to a system and method for creating, organising, disseminating and/or providing exercise programs. Numerous aspects of invention are disclosed in this application.

### FIELD OF INVENTION

The present invention relates to the Exercise Industry.

In one form, the invention relates to a system and method for creating, organising, disseminating and/or providing exercise programs.

It will be convenient to hereinafter describe the invention in relation to exercise programs, however it should be appreciated that the present invention is not limited to that use only.

### BACKGROUND ART

The discussion throughout this specification comes about due to the realisation of the inventors and/or the identification of certain prior art problems by the inventors.

The way that Coaches conduct their businesses can vary from being full time and professional to part time and amateur. Irrespective of the nature of the Coaching business, Coaches are often tied down doing paper work, speaking to Clients and instructing them how to perform the exercises that are prescribed, as well as analysing the work completed in order to provide quantitative feedback.

Coaches have specific skills in the prescription of exercise, the teaching of skills and in providing qualitative feedback regarding performance for a particular sport or industry. However, there is diversity in the additional skills and knowledge attained by Coaches in other areas pertaining to sport, exercise, rehabilitation and other forms of human movement such as computer and software literacy, understanding of applied physiology, mathematics and quantitative analysis are and are varied and quite often limited.

Word processing and spreadsheet software are common applications which Coaches plan, build and deliver the programs; however the detail and specificity of the training programs can be limited by the computer skills of the Coach. Furthermore, these applications do not provide the specific functionality and tools required in order to create the desired programs.

The inventor(s) have further realised that there are a number of problems associated with the prior art, and/or customer needs which need to be addressed, including the following:

The general requirements of Coaches are to plan and design the appropriate Exercise or Training program for each team or individual, teach the individuals how to complete the exercises and to provide feedback to the individuals about their progress. The exercises that are appropriate for the Client's are dependent upon many factors which include but are not limited to the sports, nature of an injury, individual goals of the Client, access to equipment, skills and exercise experience, and type of exercise most enjoyed by the Client. Coaches are continuously researching for new ideas for exercises for their Client's to do however it is very difficult to communicate such diversity of exercises.

Constructing and formatting the required program templates is considered time consuming and cumbersome. The format and structure of the Exercise and Training programs vary significantly depending on but not limited to the number of weeks, the number of days per week and the number of sessions per day that the exercise is to be completed. Each program template needs to be created specifically to cater for the individual requirements of the respective Clients. It is considered wasteful to have numerous exercise templates which attempt to cater for all of the endless possibilities of program design.

In the past, Exercise programs and Training programs that are created in software such as spreadsheets and word processing respectively require the rows and columns are adjusted to create the required program template. However, in doing so, creating the required Exercise and Training program template specific to every individual is a time consuming process and the quality and functionality of the templates is limited by the Coach's skills in the respective software.

There are also many ways that an exercise can be completed which include but are not limited to; repetitions, time, a rating of perceived effort, distance and a percentage of tested maximum lifts.

Other details are often required to instruct the client how to complete the exercise and include but are not limited to rest time between sets, the speed that the exercise is completed, the athletes rating of perceived effort having just completed the exercise and whether the exercise needs to be completed in different directions or for both limbs.

There is no commercial system available which contains the required elements required to prescribe how an exercise is to be perform and undertaken.

Although the prior art representations using spreadsheet and word processing are a common software environment to create and customize exercise tables to display the required information for the exercises, they require the manipulation of rows and columns to design the table format required. Furthermore and as previously mentioned, there is an enormous variety in the way the exercises can be described and compiling all of the required information into an Excel table is considered extremely cumbersome and requires significant technical know-how.

Current methods of quantifying the work that is prescribed by the Coach or for the Client to be able to quantify the work that they have completed are inefficient and time consuming. The information to be analysed includes, but is not limited to, the mode of the exercise, the predominant physiological systems that are emphasised during the session the volume and intensity of the exercise and training session. Furthermore, quantitative information that is also necessary to analyse is the work completed by the Client in addition to their rating of perceived effort for the respective exercises and sessions.

One way of quantifying the work is to analyse the data by manually setting up macros in software such as spreadsheet or databases and create the required graphs accordingly. However, adequate skills are required to be able to create customised macros using these forms of software. Manually creating the graphs takes time and there may be problems associated with the creating of the require links and calculations. In many situations, the Coach may not have the knowledge about the various training elements that are able to be analysed.

Furthermore, current methods of creating and communicating electronic forms of Exercise programs, Training programs (collectively referred to as Programs), Annual Plans and Training Diary data, require multiple files often numerous forms of software. Managing multiple files with potentially different forms of software is time consuming and labour intensive.

Each file needs to be saved individually into a folder in the file directory and in order to view all of the programs; all of the respective files need to be opened individually. Furthermore, analysing the data from the numerous files, various software and web based applications is technically difficult and not user friendly. The functionality of current spreadsheet and word processing software is considered limited with the detail in which it can create of Programs, Plans and Training Diaries in numerical, tabular and graphical format in a simple and user friendly manner and in the same environment and within the same file.

Stand alone software applications for Program design, Planning and Training Diary input are considered limited with their capability of to creating an all encompassing programs that contain the Plan, various forms of Programs and Training Diary information in the same software and within the same individual file.

Generic spreadsheet or word processing software applications have the functionality for the Coach to create various programs, plans and Training Diary templates. Assuming the Coach either has, or has access to the required technical skill, the Programs and Plans can be created and communicated from one user to another. The information associated with spreadsheet based software is able to be analysed and represented in a graphical and tabular form.

Exercise Programs are often prescribed numerically to sets of repetitions, Annual Plans are often in tabular, graphical and textual forms, and the Training programs often contain a combination of numerical and textual descriptions. Furthermore, the format of the Training Diaries may vary significantly whether they are via stand alone software or web based applications. The training diaries may also contain formulae of which to analyse the data entered by the Client. Consequently, the software applications used need to cater for the various forms of program prescription and data input, resulting in the use of multiple program files and potentially numerous forms of software to handle the various Programs, Annual Plans and Training Diary designs.

Using various software applications and numerous independent files for each training program makes it difficult to analyse the data associated with the Programs, Plan and Training Diary in a time and cost efficient manner,

Equally, analysing the data directly from the numerous and independent files and potentially different platforms requires significant technical know-how. Various complicated macros and algorithms are required to analyse data from these separate files and the process of entering the training results into a different application to the Training Diary information is time consuming & requires numerous steps, Consequently such lengthy processes may lead to poor adherence of data entry from the Client.

There are numerous factors which contribute to the time that is required to complete the Exercise program. Such factors include but are not limited to the number of exercises prescribed, the speeds that the exercises are to be completed and the rest time between sets. During the process of creating an Exercise program, the Coach needs to be able to calculate the approximate time that the program will take to complete.

Currently, the Coach either relies on experience to be able to estimate the time that the Exercise program should take to complete or manually adds up the time for each exercise and for the entire session. The current methods are considered time consuming and are open to miscalculations.

There is enormous variety and individuality about the information that is required in pre-populated tables. Considerations need to be made depending on the nature of the sport, the athlete or other requirements of the respective exercises. It is has not been possible to pre-populate all of the required tables to cater for every situation in relation to exercise prescription.

There are numerous ways which exercises can be taught to an individual. The process usually requires verbal instruction and demonstration by the Coach which is followed by an interpretation and implementation by the Client. Coaches may need to provide feedback where appropriate and to master the skill and the Client needs to practice. In most circumstances, the Coach cannot always supervise the Clients every time they practice the exercises and consequently, it is common for the Clients to forget exactly how to perform the exercises.

Current strategies which Coaches adopt to communicate to the Client include but are not limited to photocopying images from books or magazines, creating drawings of the exercises and either post, fax or scan and entail the drawings to the Client, filming the exercises and saving them onto a CD-ROM, providing three dimensional animations of the exercises, writing detailed text descriptions of the exercise or explaining how to complete the exercise over the phone,

Seeing an exercise being completed in its entirety is considered one of the most natural and effective ways to learn a new skill. Detailed text descriptions can provide important coaching tips or exercise cues for the exercises, especially considering that there may be important things to take into account when performing an exercise which may not necessarily be seen on a picture or even as someone else performs the exercise.

Verbally communicating the exercise enables the Client to ask questions about the exercise rather than the communication lines remaining one way. Clients may have individual difficulties which can only be clarified or rectified by talking through the issues.

However, in general, a photograph or two dimensional illustration of the exercise cannot demonstrate the three dimensional components of the exercise, especially for circumstances in which the movements are dynamic and technically complicated to complete. Photocopying the required pictures requires access to an enormous library of books which contain all of the exercises that are required and purchasing all of the required books and magazines is an expensive alternative. Drawing the exercises requires adequate artistic skills from the Coach and stick figures and two dimensional illustrations do not clearly illustrate how to perform the exercise. Once the drawings are complete, the Coach has to either photocopy the exercises or convert the images to an electronic format to be emailed. This process is time consuming and the variety of exercises is restricted depending on the artistic skills of the Coach. Filming the required exercises requires adequate skills and the appropriate hardware and software to film the exercises and save them onto a CD-ROM. The use of movie files alone to demonstrate the requirements of the exercise do not highlight the dangers or the finer technical qualities or teaching cues of an exercise which are not evident by the naked eye. Generating animations of the exercises takes extraordinary technical know-how and is a costly process. The 3-D animations may still not fully illustrate how to perform the exercises in their entirety. Descriptive text instructions are considered to be open to misinterpretation and will take time for the Coach to author the required text and also for the Client to read and comprehend the requirements of the exercise. Verbally instructing the exercise takes significant time, especially if the Coach has many Clients, and the instructions may still not be adequate for the Client to grasp how to perform the exercise,

An important aspect of the exercise, health and fitness industry is that the Client enjoys the experience. Client's who have to try to interpret still images, drawings or photographs may not enjoy the coaching process. Ultimately, the Client wants to enjoy performing the exercise and not be bothered or become frustrated with misinterpretations and miscommunications about how to accomplish their training.

Exercise Objects contain movie files and three photos and other associated links. A single Exercise program may contain numerous Exercise Objects which will result in an enormous file size and is loo large to be emailed. Previously, websites have been available for Coaches to subscribe to and which contain movie files and images in addition to exercise templates. The Coach could subscribe to the website and access the required information in accordance with the functionality provided by the respective websites.

The websites may contain the functionality to create Programs, Annual plans or record Training Diary data. Instead of communicating the information from one user to another via email or other suitable communication means, all of the Program and Annual plan information is retained on the respective websites.

Websites require the users to be online when accessing the Programs and Annual plans. Depending on the speed of the internet connection, the process of accessing numerous pages online can be time consuming.

Also, the Coach or Client may not have frequent access to the internet and in situations where the internet connection fails or if the host server has technical difficulties, the data cannot be accessed or uploaded to the respective websites and thus, the Coach or Client could not access the required information. Furthermore, the screens take time to refresh and downloading files may be lengthy depending on speed of internet connection. Dial up connections may tie up the phone line and being online exposes internet users to computer viruses.

Over the course of time, a Coach will create a lot of Exercise and Training programs and will develop an archive of numerous individual training sessions.

In many circumstances, a Coach may need to re-use some of the training sessions that he/she has created for other Clients or may even need to exchange the training sessions with other Coaches and have other Coaches exchange sessions amongst themselves. Currently there is no efficient way to be able to search the archive of training sessions that have been created to be able to re-use the training sessions.

The requirements of Coaches and Clients can be very individual and specific to the various sports and activities in which the parties are involved. The Invention contains common exercise and physiological metadata elements but it cannot cater for all of the terminology and intricacies of every sport, exercise or human movement term.

Any discussion of documents, devices, acts or knowledge in this specification is included to explain the context of the invention. It should not be taken as an admission that any of the material forms a part of the prior art base or the common general knowledge in the relevant art in Australia or elsewhere on or before the priority date of the disclosure and claims herein.

A further object of the present invention is to alleviate at least one disadvantage associated with the prior art.

### SUMMARY OF INVENTION

The present invention provides, in one inventive aspect, a method of and/or device for communicating an exercise representation from a first client to a second client, the method comprises the steps of providing an information file, communicating the information file from the first client to the second client, and the second client, upon receipt of the information file, creating the exercise representation with reference to a database.

The present invention provides, in an inventive aspect, a method of and/or an authoring tool adapted to be used in association with an exercise representation, comprising linking means adapted to identify a link(s) to information stored in the database and means adapted to create the link(s).

The present invention provides, in another inventive aspect, a method of and/or device for creating an exercise representation adapted, the method comprising the steps of receiving an information file, and creating the exercise representation using the information file together with an exercise object.

The present invention provides, in another inventive aspect, a method of and/or device for configuring an template adapted to be used in the execution of an exercise routine, the method comprising the steps of providing a program dialogue adapted to enable user selected configuration of a template for use in the exercise routine, and selecting from the program dialogue a desired format for the template.

The present invention provides, in another inventive aspect, a method of and/or device for estimating the duration (T) of execution of an exercise routine performed by a user, the method comprising the steps of assessing an exercise table and determining T in accordance with T=(totalTime*set2+rest2*(set2−1))*set1+rest1*(set1−1)

The present invention provides, in another inventive aspect, a method of and/or device for analysing data representative of an exercise routine performed by a user, the method comprising the steps of accessing the data representative of the exercise routine, selecting a portion of the data to be analysed and performing the analysis based on information resident in the exercise object table.

The present invention provides, in another inventive aspect, a method of and/or an exercise object table, comprising an exercise object based on an information file, and an exercise record adapted to record predetermined information regarding the exercise and/or a client's performance of the exercise.

The present invention provides, in an inventive aspect, a method of computer program product and/or apparatus adapted to provide an exercise for an exercise program, said apparatus including processor means adapted to operate in accordance with a predetermined instruction set, said apparatus, in conjunction with said instruction set, being adapted to perform the method as herein disclosed.

The present invention provides, in a further aspect of invention, a method of and/or device for communicating an exercise program from a first device to a second device, the method comprises the steps of enabling access of the first and second devices to a database having a plurality of exercises stored herein, communicating an information file from the first device to the second device, the second device, upon receipt of the information file, creating the Exercise program with reference to the plurality of exercises.

The present invention provides, in another aspect of invention, a method of and/or an authoring tool adapted to be used in association with an Exercise program, comprising linking means adapted to provide link(s) between information stored in the database and a particular exercise.

The present invention provides, in a still further aspect of invention, a method of and/or device for creating an exercise adapted to be communicated from a first device to a second device, the method comprising the steps of determining portions of information in a database, creating the exercise by providing at least one link between a plurality of the portions information.

In accordance with an aspect of invention, the client or application may communicate via and/or have access to a website.

Other aspects and preferred aspects are disclosed in the specification and/or defined in the appended claims, forming a part of the description of the invention.

With regard to the manner in which an exercise is created according to the invention, in essence, the creator of the Exercise program and the recipient both has stored database elements and substantially the same associated exercise links. Therefore, in order to communicate Exercise and Training programs or other information, the end user must have a version of the application or access to the inventors' website which contains the same database elements.

The file which comprises of the Exercise program contains the collection of the Exercise ID's (102). The Exercise ID's are associated with all of the metadata links and the links which create the Exercise Object (800). It is the links associated with the Exercise ID which read the databases and extract the relevant information. The Exercise and Training programs do not contain the raw media and textual information which is associated with the exercises.

As the file is saved, it is compressed to further reduce the file size. When the file is emailed to the end user, or uploaded to the website, only the series of Exercise ID's and any other text associated with the program such as notes, etc are sent. The end user opens the file and the application or the website automatically creates the template required, the Exercise ID's read to the respective tables in the Application or website Database through the associated links, and the relevant information is extracted and displayed in the user interface.

The Training programs which are emailed contain the text associated with the training sessions; any exercise links which are imbedded in the training sessions as well as the metadata links. The Training program is saved and the file is compressed further. When the file is opened by the user, the application or website creates the required template and any exercise links imbedded in the Training program are linked to the respective exercises in the Application or website Database.

With regard to the manner in which the data is stored and/or tagged in the invention, in essence, the appearance of an exercise within the application is determined by the Exercise ID and is referred to the Exercise Object (800). The Exercise ID associated with the Exercise Object contains the numerous links to the respective information being displayed and includes the illustration of the photo of the exercise, the sketch, the difficulty level and the link to the movie file and the link to the More Info page. The More Info page also contains numerous links which include the link to the movie file, the illustration of the photo, the difficulty level, links to the related exercise, More Info pages and the links to the Prime Movers More Info page.

The links that are associated with the Exercise ID and the More Info are created in the Authoring Tool (100). The Authoring Tool is designed to enable all of the links to be associated with the exercises throughout the application and to enable the files created using the application to retain the exercise links to be emailed to another user or uploaded to the website.

Some of the events which occur to create the Exercise Object are automatically generated and other events are required to be completed manually. The movie and photo files are stored in a folder and the movie and photo file for the same exercise have the same numerical file name but contain different file extensions. The Authoring Tool reads the exercise number from the media folders and links the newly created exercise number with the movie and photos which contain the same numerical filename.

Free text is entered into the Authoring Tool to author the tips, cautions and to input numbers of the two related exercise links. Furthermore, the Authoring Tool also contains a series of metadata elements. Each of the metadata elements have a unique Identification number (ID) associated to it. The metadata elements which represent attributes and characteristics of the exercise are manually selected to tag the respective element to the exercise being authored. Ultimately, the metadata elements which are selected are tagged specifically to the Exercise ID and therefore the metadata element ID's are also associated with the Exercise ID. The metadata elements and the information that is entered into the Authoring Tool are distributed into different tables in the Application Database.

In one form, Table 111 stores the Exercise ID, tips, cautions, the sketch ID and difficulty level, table 112 contains the Exercise ID, the Metadata ID and a data reference, and table 119 contains the Exercise ID with the related exercise ID's for the respective exercise.

The exercise authoring process serves numerous purposes (FIG. 1, for example). Some of the elements which are tagged contribute to the appearance of the Exercise Object (800) which includes the difficulty level (804), the sketch (805) and the link to the More Info page (803).

Another purpose of tagging the exercises with the metadata elements is to enable the exercises to be searched and retrieved in the application. The search pages (113) are comprised of many of the same metadata terms, and corresponding ID numbers as the metadata terms contained in the Authoring Tool. When the metadata elements are selected during the search process, the exercises (the Exercise ID's) which contain the matching metadata ID are retrieved from the tables in the Application Database and are displayed.

For the exercise search, the Boolean operation AND and OR can be determined on this page. The AND operation retrieves exercises which contain all of the metadata elements selected; whereas the OR operation retrieves the exercises which contain any of the metadata elements selected.

As a consequence of the extensive exercise authoring process, the Exercise Object is merely the product of comprehensive links to the tables in the Application Database to display the required information which correspond with the Exercise ID number. Wherever the Exercise ID appears throughout the application and website, amongst programs and in files that are emailed and exchanged, the Exercise ID extracts the information from the tables in the Application Database and from other folders in the Invention itself.

An aspect of invention contains the functionality to create the Annual Plan, Exercise program and Training program and record Training Diary data in substantially the same file and within substantially the same software application. Therefore, to communicate all of the programs, substantially only one file needs communicated (such as via email) to the end users, as long as they have a form of the software and/or access to the website.

The data associated with the programs, the Training Diary and the Annual plan can be analysed and compared from one file The invention does not rely on external software or specific websites to handle all of the data.

The creation of programs and plans is undertaken in the software application and is not reliant on a website. This alleviates the need to be online, which is more time efficient, and all of the information is stored on the hard drive or disk rather than a server. Alternatively, the data associated with the functionality of the Invention enables the Programs, Plans and Training Diary data to be uploaded to the inventors' website for storage and analysis.

In essence, the present invention enables:
Analysis of data—The invention offers numerous ways to analyse the data which is associated with the work that is prescribed and the work that is completed.
Education—The invention contains education modules in addition to educational links within the various modules throughout the application. The educational information contained in the application covers a broad range of industries and can be applied in many forms.
Coaching—The invention relates to a system of designing, organising and disseminating coaching and training session plans.
Planning—The invention contains a system of creating and customising Annual Plans which provide an overview of the training year and govern the design and content associated with other forms of Exercise and Training programs.
Associates exercises, data and/or information associated with exercises with human body parts.
Can be applied to the World Wide Web—The current invention will be integrated into a website and will relate to the fields of Software and World Wide Web technologies.
One aspect of the invention is the extensiveness of the information contained in the application. In particular, a large number of exercises are contained in the database.
The invention contains numerous modules and functionality which are designed to cater for such a broad industry which encompasses but is not limited to exercise prescription, education, applied physiology, coaching, health and fitness and rehabilitation.
The various modules contain pre-loaded data and information which is contained in the databases of the application. However, the user is able to customise the presentation and the content of the relevant modules specific to the individual needs.
The invention contains numerous methods of communicating the information amongst peers and between Clients. The methods and mediums used to illustrate and instruct how to perform the exercises contained in the application caters for the various forms of learning and is suitable for all levels of skill and experience of both the Coach and the Client.
The invention contains numerous forms of organising and presenting the exercises and the programs that are created which caters for the various styles of coaching, exercise prescription and teaching. The application is suitable to users of various levels of knowledge and academic backgrounds.
In order for the users to exchange and communicate the information contained in and created by the application, all parties must have installed a version of the application or access to the inventor's website.
The aforementioned attributes of the invention are organised in such a way which enables the various modules and components associated with the modules to integrate throughout the application. Associating the programs and files with fixed dates and fixed data elements enables the invention to read, compare and integrate the respective files and programs. This unique design and integrated functionality across the application provides a dynamic working environment to cater for the many needs and requirements of users in the related industries.
The invention, in one form, contains an extensive database of exercises and associated information. Functionality attributes of the invention integrate with the databases to reduce the time required to create exercise programs and improve the communication of the prescribed programs through the various forms of rich media and qualitative and quantitative means.
The invention enables the Client to record subjective and objective information into a Training Diary system for analysis of the physical, physiological and psychological responses to the Exercise and Training programs.
The invention stores data associated with Training programs and Exercise programs in the one file, streamlining the process of communicating and analysing the data associated with the respective programs.

The present invention has been found to result in a number of advantages, such as:
The invention provides the framework and functionality for the Coach to successfully and quickly manufacture the required Exercise and Training programs. The invention is specifically tailored to the aforementioned industries and is not cluttered with additional and unnecessary features or functionality contained in other software applications used in the prior art,
Saving time has a direct influence on the number of chargeable hours that the coach can spend for each Client. For example, prior art methods adopted to create an Exercise or Training program may enable the Coach to create one training program per person in an hour. However, due to the numerous time saving innovations incorporated in the present application, a Coach may be able to create numerous Exercise or Training programs per hour. In effect, this enables the Coach to become far more productive,
the detailed information associated with the Exercise and Training program decreases confusion or misinterpretation of the prescribed information. Therefore, the time that the Coach spends communicating to the Client in relation to the intricacies and finer details of a program is reduced,
the Exercise programs can be compiled on a computer, and communicated, such as via email or the internet, to a client,
having immediate electronic access to an extensive database of exercises and educational information enables Exercise and Training programs to be created more efficiently. This decreases the reliance on books and journals which saves money which would otherwise be spent on purchasing such resources. Obtaining information from books and journals is a time consuming process due to the way in which the information is organised,
Custom Exercise templates that are created using a dialogue system reduces the time taken to create the templates and eliminates the need to format tables which are otherwise developed in word processing and spreadsheet software.
The development of the Exercise templates is not dependent upon skills which are otherwise required with word processing and spreadsheet applications.
Detailed Exercise tables reduce the need to format and create customised Exercise templates to enter any required information.
The tables are formatted within the application for Exercise and Training program elements to be imported into.
The tables require little, if any additional formatting for such tasks as copying, pasting, and printing and so on. The dropdown lists of pre-defined industry terms and elements which are contained in the tables provide numerous ways to describe the workload of an exercise. The dropdown lists save time and eliminate any problems associated with font size selection and other text formatting problems.
The Coach can analyse the data elements which are imported into the Exercise and Training programs instead of having to develop separate algorithms or macros using other software. The functionality and the detail of the data analysed in addition to the graphical representation of the data do not rely on the mathematical skills of the user.
The Coach cannot afford to waste time adding up or estimating the duration of time that the exercise or session will take to complete. The invention displays the duration of the prescribed exercise or session which eliminates the task of manually calculating and estimating the duration of the sessions, which is open to human error.
Filling Exercise tables automatically with tables which contain pre-populated data saves significant time and intellectual energy.
Having the capability to customise the tables of data that encompass the auto fill function provides the user with unlimited options which are specific to the needs and requirements of the respective industries.
Providing the Client with exercises which contain various forms of instruction and information, particularly movies and photos relating to the respective exercises, decreases the Client's reliance on the Coach. This decrease in reliance saves the Coach time and intellectual energy which may otherwise be spent communicating to the Client.
The Exercise and Training program files contain links to the databases in the users' software, rather than the raw images and media, which enables all of the information relating to the programs to be communicated via email. This improves the method of electronic communication between the Coach and Client without relying on a website.
Having the capability to create a Training program by importing training sessions that have already been authored saves significant time and intellectual energy. This capability allows the Coach to produce a Training program with all of the required information in a shorter space of time. The databases containing the sessions is scalable so that the more training sessions that are created, tagged and saved, the less a Coach will need create training sessions from scratch.
Providing Coaches with the capability to exchange training sessions in a format that enables them to efficiently save and then search the sessions creates a unique Coaching network system. Coaches can benefit from the knowledge and experience of other Coaches in a way which will vastly improve the quality of their coaching business.
The search page user interface rapidly displays the Exercise and Single Session search results enables the respective programs to be created faster. The immediate display of search returns also confirms whether the correct search was conducted in the first instance and enables the Coach to make additional searches quickly.
Keeping the Search Results displayed while navigating throughout the application and between the various files that may be open enables the user to work on numerous files at the same time without having to leave the screen or minimise the files. This decreases the total movement required with the mouse during the creation of the various files and consequently saves time and decreases the intellectual processed required.
The creation of small file sizes reduces the demand on the memory and hard drive space of the user's computer, which is particularly important considering all of the Exercise programs contain references to numerous movie and photo files. The small file sizes also enable the files to be saved onto a disk which makes the use of the application attractive for people who travel frequently and do not have may not have regular access to the internet. This enables the Coach to continue training the Client without being restricted due to limited internet access, which ensures a continued income stream.
The small file sizes enable the navigation throughout the application to be very speedy, and consequently do not place much stress in the users system. This enables the user to have multiple applications open at the same time while creating numerous programs and multi tasking. Consequently, the users can continue with all of the other work which is required without having to close the application.
The invention contains specific education modules, in particular the Anatomy and Glossary modules which provide an extensive array of information relating specifically to the exercise and related industries. In addition to the specific education modules, the invention contains numerous forms of education and information within the modules such as pop-up graphical illustrations and tabular descriptions of the various elements contained in the modules. Therefore, the user does not need to seek as many additional resources and educational material whilst using the software.
The invention is capable of being incorporated into the education system and used as a medium to teach students about many of the components pertaining to exercise prescription, coaching, health and fitness, rehabilitation, planning and any other fields relating to human movement studies.
Providing alternative display modes for the way that the exercises appear in the Exercise programs increases the number of exercises that can be viewed on the screen which decreases the amount of vertical scroll required. By hiding the Exercise table, the display of exercises is clearer and appears less cluttered.
Having the capability of building Annual Plans which require no further calculations or numerical formatting makes the building process less daunting and less intimidating than current methods.
The process of creating graphs via a combination of single clicks or by dragging the cursor speeds up the generation of the graphs and the capability to edit the graphs at any stage makes them user friendly. The freedom to manipulate the graphs as desired without affecting any other code or formulae associated with previous art encourages the users to constantly review the plans. Furthermore, the users can adjust the graphs at any stage without hassle and without requiring any technical skill.
The available graphs provide the users with the capability to set out and govern the way in which the training sessions are designed for each phase in the training year in a graphical form. The various forms of graphs enable the Coach to either create a plan for the entire year or create individual graphs for all of the weeks of the year. This in turn provides the Coach with a general guideline about the events and the related components which constitute the year in addition to providing information specifically for the individual weeks of the year.
Providing the functionality to analyse the Programs and additional data directly from the Annual Plan within the same file allows the user to make an informed decision about the results of the analyses based on the information presented in the plan. Consequently, alterations or amendments can be made based on quantitative and qualitative information that is illustrated from the analysis.
Being able to customise the terms contained in the Annual Plans ensures that the plans can be individualised for the Coaches as well as for the teams which the Coaches may work for. The variety of graphs and associated information that can therefore be displayed in the plans is unlimited and can be tailored specifically to the various needs of the users.
Reduces the time required for the Coach to communicate the program to the Client and support staff. As a result of the time saving benefits of the invention, the Coach can either work with more Clients in order to increase business or have more spare time available.
Eliminates the reliance on other software applications and website subscriptions which can be costly.
Programs can be viewed directly from the Annual Plan which saves time and intellectual energy. Advantageously, the invention eliminates the necessity of saving numerous files in the directory and then having to recall each of the file names of the respective files.
Does not require setting up macros or formulae to analyse the Programs and Training diary. The invention does not require technical know-how in order to create the required Plans or Programs. The templates and functionality are predefined and specifically designed for the creation and communication of various forms of programs and plans. Therefore the handling of the Programs, Training Diary information and Analysis is user-friendly and technically simple, eliminating the reliance of complicated formulae and macros.
Requires one file to be communicated to the Client rather than multiple files. Therefore, the Client handles all of the prescribed programs and information in a more manageable form. The management of all of the programs in one file decreases the potential for the programs to be misfiled amongst other files in the file directory.
The streamlined method of data collection improves the efficiency in which the physical, physiological and psychological information is obtained by the user. Accordingly, the Client's adherence to the data entry process may result in obtaining more reliable and regular data. Furthermore, the invention decreases the number of steps required to compare the data between the Programs, Training Diary and the Annual plan and other data.
The physical, physiological and psychological information associated with the completion of Programs and from the Training Diary data entry can indicate trends with regard to performance, fatigue and overtraining. Early recognition of symptoms overtraining is integral with regard to the prescription and modifications of Programs.
   Terms

Throughout the present specification:
Coach—refers to an individual from any industry who is involved the study and/or prescription of exercise, stretches or any other form of human movement in the sporting, coaching, education, health and fitness, rehabilitation and recreation industry.
Client—refers to the athlete, patient, coach, client or the individual or team of individuals conducting the exercises, stretches or any other form of human movement.
Programs—Is a general term which encompasses all of the types of systems, database, libraries and/or files which can be created using the invention and include Training Programs, Single Sessions, Exercise Programs, Workboxes and Annual Plans.
Single Sessions—is the individual training session that the coach creates and prescribes for a specific day or period of the day,
Training program—is a program which is created and contains a collection of single sessions which are text files that may contain exercise links.
Exercise—refers to an exercise, stretch or form of human movement which has been created and uniquely coded with metadata elements.
Exercise object—refers to the visual representation of the exercise which includes the following elements photos, movie link, more info link, body sketch and exercise name the elements are created via links to the respective ID's in the database
Exercise representation—refers to one or more exercise(s) or a portion of an exercise(s) and may include information sufficient for a client to understand or perform an exercise(s).
Exercise program—is a collection of exercises from either one of two exercise templates-an advanced template and a basic template which mainly contain tables and numerical data.
Exercise Industry—is any industry which encompasses sport, coaching, health and fitness, exercise prescription, rehabilitation, education and/or any form human movement.
Annual Plan—Is a file in the invention which reflects an overview of the training year for a team or individual. The Annual Plan contains functionality which allows the user to manipulate the appearance and enter the required information.
Training Diary—Is a form of recording physical, physiological responses to training and general psychological states of wellness. The data recorded in Training Diaries varies depending on the information required.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

Further disclosure, objects, advantages and aspects of the present application may be better understood by those skilled in the relevant art by reference to the following description of preferred embodiments taken in conjunction with the accompanying drawings, which are given by way of illustration only, and thus are not limitative of the present invention, and in which:

FIG. 1 illustrates one embodiment of an authoring tool and the customisation of the search page according to one aspect of the present invention,

FIG. 2 Illustrates one embodiment of new program dialogue according to an aspect of the present invention,

FIGS. 3a and 3b illustrates an exercise table according to an aspect of invention,

FIG. 4 illustrates a method of analysing the information contained in the exercise tables and the exercise and training programs,

FIG. 5 illustrates method of estimating the time that an individual exercise or the entire exercise program should take to complete,

FIGS. 6 and 7 illustrate a list of pre-populated exercise tables which reflect intensity, physiological adaptation and the method as well as the customize capabilities and the user interface according to an embodiment of the invention,

FIG. 8 illustrates a method of compiling and/or communication exercise programs according to the invention,

FIG. 9 illustrates the communication of exercise and training programs according to an aspect of the invention,

FIG. 10 illustrates a database and application interface used with a system according to one aspect of the invention,

FIG. 11 illustrates user database used with a system according to one aspect of the invention,

FIG. 12 illustrates the user interface according to one aspect of the invention,

FIG. 13 illustrates the user interface relating to importing exercises into a program,

FIG. 14 illustrates the user interface relating to the functionality associated with the Annual Plan according to an aspect of the invention and

FIG. 15 illustrates an Annual plan of which the Exercise program and a Training program is embedded.

### DETAILED DESCRIPTION

The invention provides the framework and functionality for the Coach to successfully and quickly manufacture the required Exercise and Training programs. The invention is specifically tailored to the aforementioned industries and is not cluttered with additional and unnecessary features or functionality contained in other applications such as Microsoft Word and Excel.

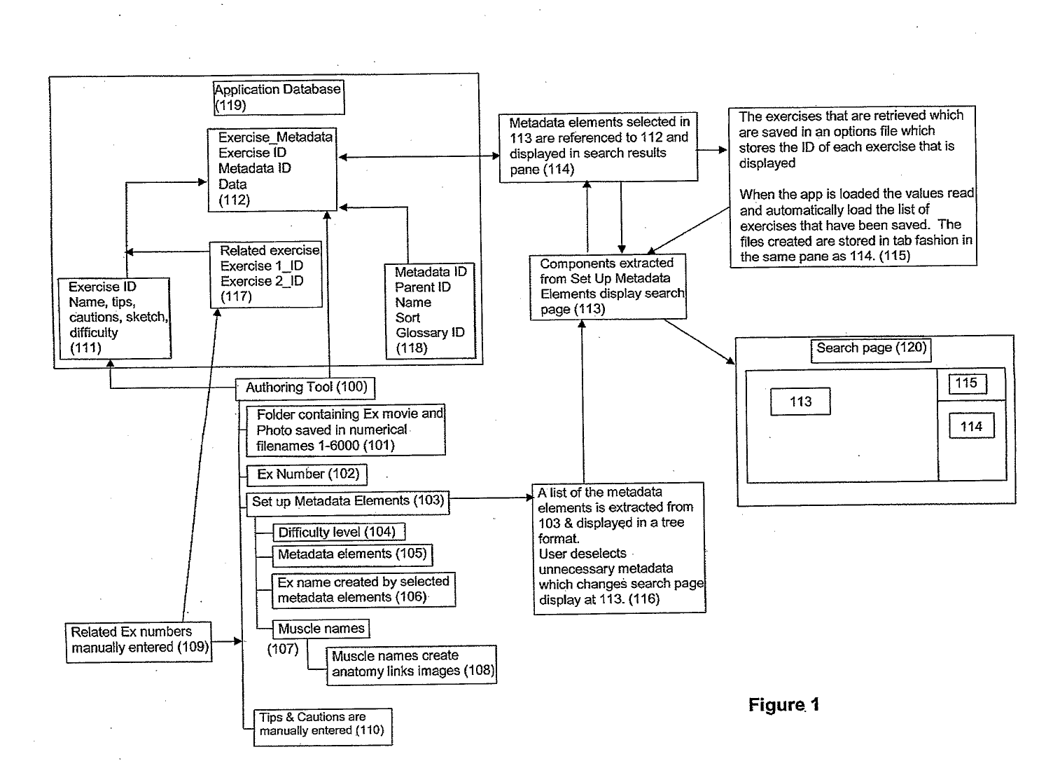

Referring to FIG. 1, an authoring tool according to one aspect of the present invention is shown. In FIG. 1:

100—represents an authoring tool which is the environment which all of the exercises are coded with the respective information and data links. The information imported into 100 is directed to various tables in the Application database,

101—represents a folder which contains the movie files and the photo files and each filename is saved as a unique number. The movie and photo of the same exercise contain the same file number but different file extensions to ensure that the movie and photos for the corresponding exercises remain together,

102—represents an exercise number which is automatically generated and corresponds to the number which is used to name the movie and photo files,

103—represents a series of metadata elements. The metadata elements in 103 are selected according to the components that are relevant to the exercise being authored,

104—represents a sub level in the 103 which represents the difficulty level of the exercise. The appropriate box is selected according to the difficulty level of the exercise,

105—represents an extensive list of metadata elements which describe all of the parameters and components that are characteristic to the exercise being authored,

106—represents particular metadata elements that are selected in 105 which determine the name of the exercise,

107—represents a list of the muscles which are contained in the Anatomy module and referenced throughout the application. The list of muscles are selected to link the Prime Movers to the exercise,

108—represents a list of body regions which correspond to the body parts which are predominantly used during the exercise and are identical to the regions associated with the search morph in the application. The regions are selected for each exercise to link the morph regions to the exercise. The sketches also contain the same regions as the morph and are automatically linked to the exercise also,

109—represents the exercise numbers of two similar exercises to the exercise being coded and are imported into 100. The exercise numbers are stored in 117 and display on the more information when the link is selected,

110—represents tips and cautions that are entered into 100 and are stored in the table 111. The tips and cautions are linked to the exercise from the database and display on information pop-up sheets when the link is clicked,

111—represents a the Exercise table in the Application Database (119) which contains the Exercise ID number, tips, cautions, sketch and difficulty level,

112—represents the Exercise Metadata table in the Application Database (119) which contains the Exercise ID from 111, the Metadata ID from 118. 112 is the table which the search pages are referenced to as the metadata elements are selected in 113. The items in 111 and 118 are linked to 112,

113—represents an Exercise Search page or Single Session search page on the user interface which is comprised of metadata elements from 103, the search morph (for the Exercise and Stretch search only), and displays the list of Exercises or Sessions in the search results pane (114). Each metadata element enables the user to select the metadata element to conduct the search. For the Exercise search, the Boolean operation AND and OR can be determined on this page,

114—represents the results pane (page) of 113. The metadata elements selected in 113 are referenced to 112 and display the relevant exercises in search results pane. The search results pane displays all of the exercises by default when no metadata elements are selected. The exercises displayed in 114 are determined by the Boolean operation conducted. If the AND operation is conducted, the list of exercises displayed will reduce as more metadata elements are selected. Conversely, if the OR operation is selected, more exercises will displays a metadata elements are selected,

115—represents the exercises that are saved in the search return pane (114) in the options file which stores the Exercise Identification number (ID) of all of the exercises that are displayed. When the application is loaded the ID values are read and automatically load the list of exercises that have been saved in the respective file. The files created are stored in tab fashion in the same pane as 114,

116—represents a substantially complete list of metadata search terms which is extracted and displayed in a tree format which govern the metadata elements that display in 113. If metadata elements are deselected in 116, the deselected elements are not displayed in 113 and,

117—represents a table in the Application Database in which the Exercise number and the Exercise numbers of two related exercises which were entered into 109.

118—represents the Metadata Table in the Application Database (119) which stores the ID numbers for all of the Metadata elements.

119—represents the Application Database which houses the aforementioned Tables 111, 112, 117 and 118.

120—is represents the search page in the application which contains the Metadata elements (113) the Search Results (114) and the saved search results (115),

In accordance with this aspect of the invention, there is provided an extensive database with a comprehensive exercise search and filtering facility (113). All of the Exercise Objects (800) are created using an exercise Authoring Tool (100) which is customised for this invention. Every exercise in the database is coded or tagged with the numerous links and metadata elements (103) during the creation and of the exercise database. These links remain coded to the exercises throughout the application. The search page in the invention (113) is comprised of same metadata elements which were used to code the exercises (103). This enables the exercises to be searched for precisely and quickly by selecting the metadata elements in the search page (113) which describe the type of exercise required.

Even if a large database of exercises is provided, with an extensive search filtering system, it is still likely that a large number of exercises are retrieved. Furthermore, the extensive database may contain numerous exercises that will never be required by the Coach or there may only be a select few exercises that that are required. Consequently, the total list of exercises that are retrieved from a search may be undesired and listed amongst the exercises that are being searched, and this clutters the search and result reporting process.

This is addressed by providing that exercises that are retrieved from a search return (114) are capable of being saved and stored as a list of exercises in the search results pane (115). This enables the user to create multiple lists of exercises which they have immediate access to and can import them directly into the desired location without the use of the comprehensive search page. This functionality negates the need to undertake further searches since the Coach's preferred exercises are permanently displayed. This saves significant time and the searching process is not clouded by other superfluous exercises.

Where a search of a database is required, information pages (113) containing an enormous amount of metadata elements may be used to ensure that exercises can be searched for and retrieved from the extensive database. However, in many circumstances, particular metadata elements will never be used or required. These elements will therefore be in the way and clutter and slow down the searching process.

This is addressed by enabling the invention to extract a list of all of the metadata elements which are directly linked to the metadata elements in the database (103) and display the list in a tree format (116). By default, the metadata elements are all enabled and therefore appear in the search page. However, the metadata elements can be de-selected by the user and therefore disabled which results in the deselected elements not appearing on the search page (113). The search page can therefore be customised and will only display the metadata elements that are required by the user. This results in faster navigation through the search pages and consequently increases the speed that the searches can be conducted.

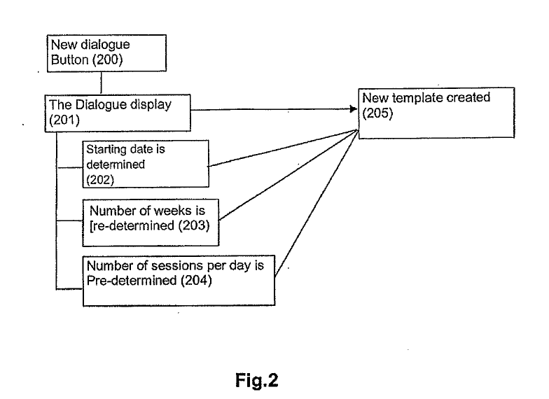

Referring to FIG. 2, one embodiment of new program dialogue according to an aspect of the present invention. In FIG. 2:

200—represents a “New” file button which is selected,

201—represents the dialogue box which contains the template selection options,

202—represents a date picker which is integrated to 200 and which determines the starting date of the file selected,

203—represents a drop list of the number of the weeks required for the template,

204—represents a table which enables the user to determine the number of sessions required for each day, and

205—represents a New template that is created and contains the information from 202, 203 and 204. The real estate required is automatically arranged depending on 202, 203 and 204

The new program dialogue (201) enables the user to pre-determine format of the template for the Exercise or Training program (205). The items which determine the format of the program include the starting date (202), the number of weeks (203), and the number of sessions each day that the exercise is to be completed (204). In addition to setting up the real estate required for the template, the dialogue automatically displays the dates, the week numbers and the names of the days of the weeks in the template also (205). The dates may be grouped into groups of weeks as displayed in that format, which reduces repetitiveness and real estate to a user.

This preliminary step in creating a new program is considered to eliminate the need to format the template any further which enables the user to immediately begin creating the desired program. This significantly saves time and decreases any potential for human error associated with using other applications to design the program templates.

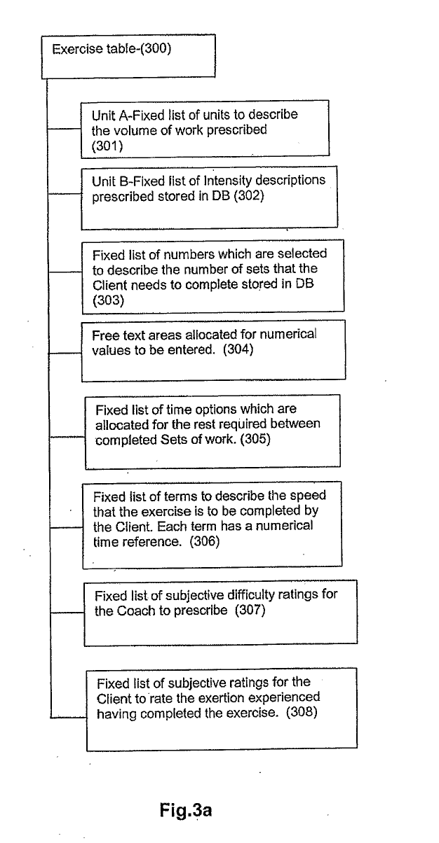

Referring to FIG. 3a, an Exercise table according to one aspect of the present invention is shown. In FIG. 3a:

300—represents an Exercise table which is a customised and unique invention,

301—represents a pre-determined list of units which describe the volume required which is contained in 300,

302—represents a pre-determined list of units to describe the intensity required which is contained in 300,

303—represents a fixed lists of numbers to determine the number of sets required which is contained in 300,

304—represents free text areas to enter numerical, values which are contained in 300,

305—represents fixed lists of time increments to determine the amount of time required to rest which is contained in 300,

306—represents fixed list of terms to describe the speed that the exercise is to be completed which is contained in 300. Each term has a corresponding numerical value relating to time in seconds,

307—represents a fixed list of subjective intensity ratings-no reference to time which is contained in 300, and

308—represents a fixed list of subjective ratings for the Client to enter into the table to describe the rating of perceived exertion experienced having completed the exercise which is contained in 300.

FIG. 3b illustrates a visual representation of an exercise table, in which 800 is the Exercise object, and is displayed in conjunction with the exercise table.

A comprehensive Exercise table (300) has been developed which contains an extensive drop-down lists of pre-defined terms and parameters which are used to prescribe the way in which exercises need to be completed (301, 302, 303, 305, 306 and 307). The fixed lists of terms eliminate human error and decreases the intellectual processes associated with prescribing the workload. Instead of developing individual Exercise tables and templates to accommodate the aforementioned parameters, the invention has organised the parameters into one table. This invention eliminates the need to create numerous Exercise tables to accommodate the various ways in which exercises can be prescribed which ultimately saves time. Furthermore, the display of the information required for prescribing the respective exercise is consistent for both the Coach and the Client and there is no need for the tables undergo any further formatting. The table also contains free text areas which enable numerical values to be inputted to describe the volume of work required (304). In addition to the exercise table and the free text field, the Exercise object is also displayed (FIG. 3b). Advantageously, substantially all of the elements required to comprehend the requirements of the exercise, the amount of work required to be undertaken and specific comments relating to the exercise are represented as one object.

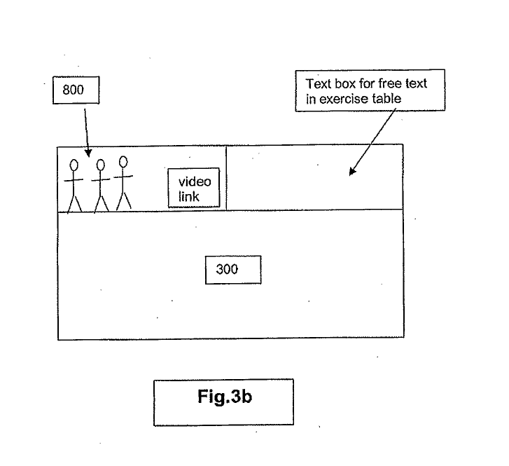

Referring to FIG. 4, a method of analysing the data of the load prescribed and the data relating to the load completed according to one aspect of the present invention is shown. In FIG. 4:

400—represents the file that is selected to be analysed and is opened from the users directory,

401—represents a table which filters and only displays the exercises capable of being analysed from the file,

402—represents a User Interface (UI) which enables the user options to select the graph they want to display. The UI provides options to filter the data by date range or exercise,

403—represents a selected graph, the application filters any exercises that are not appropriate for the current filter (402),

404—represents a table which stores the results for the graph, and

405—represents the UI display of the graph from the data in the table (404).

By performing the method of FIG. 4, the invention solution enables the Exercise and Training programs to be analysed for the various components which make up the respective programs. Furthermore, the Exercise table (300) provides the capability for the Client to input the qualitative and/or quantitative results in to the table and send this information back to the Coach to be analysed. In effect, the work that is prescribed by the Coach and the work that is completed by the Client can be analysed independently and also compared respectively.

The file is opened from the directory (400) and the exercises that are capable of being analysed are read from the program and stored in a table (401) in the database. The user selects which graph option to display and the options to filter the data according to a date range which is selected or by the body parts used (402). For the selected graph, the application filters the exercises which do not apply for the current filter (403). A table is created which stores the results for the selected graph (404) and the graph is drawn from this data (405).

The invention contains the components required to analyse the information while remaining within the application and eliminates the need to create additional macros or algorithms using other software. This capability saves time and is does not rely on the mathematic or analytical skills of the Coach in order to analyse the information.

The invention offers numerous forms of which to analyse the data by way of exercise, body part, time or physiological, psychological and physical attributes. This functionality provides the user with a graphical representation of the components which constitute the Exercise and Training programs. This graphical representation can be used to compare the desired components of the program being created with the actual components which are prescribed. This “checking” process ensures that the physiological adaptations intended by the coach during the development of the programs are being represented in the respective programs.

Being able to select the date range (402) enables the work load to be analysed according to a period the year rather than being forced to analyse each program individually. This provides the user with greater flexibility in relation to the information which can be analysed without having to open all of the programs in mention.

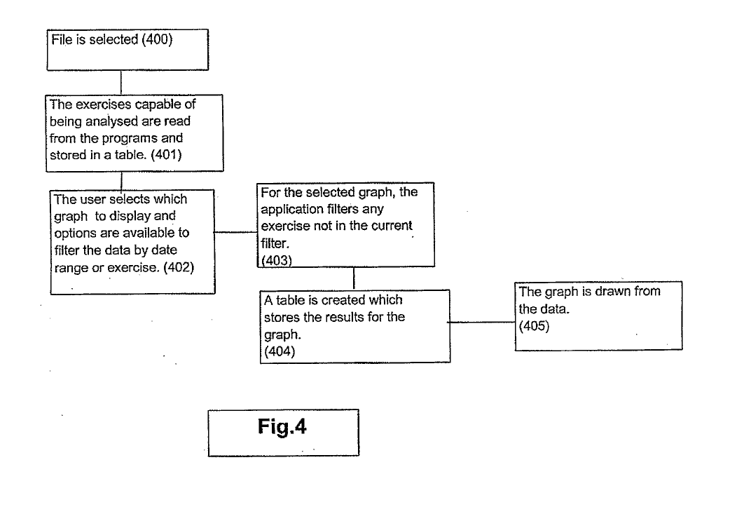

Referring to FIG. 5, a method of estimating the time that an Exercise program should take to complete according to one aspect of the present invention is shown. In FIG. 5:

500—represents appropriate data elements from table 300 are inputted into an algorithm contained in the application.

The organisation and design of the Exercise table (300) enables an algorithm to automatically calculate the duration of the sessions prescribed based on the elements selected from the 300. The table contains fixed time (305, 306) and numerical values (303) in addition to numerical free text fields (304) which enable the algorithm to calculate the table elements and to tally the time accordingly. The algorithm adds up the fields of tables which contain reference to time. Thus the total time T is given as:
T=(totalTime*set2+rest2*(set2−1))*set1+rest1*(set1−1) equation 1

whereby totalTime is the numerical entry in 304 which is in reference to time or the calculation of the numerical entry 304 by the tempo 306; set1 and set2 are the fixed numerical lists in 303, rest1 and rest2 are fixed numerical lists in 305. The calculation is applied using this formula and is determined by the values that are entered into the Exercise table elements (300).

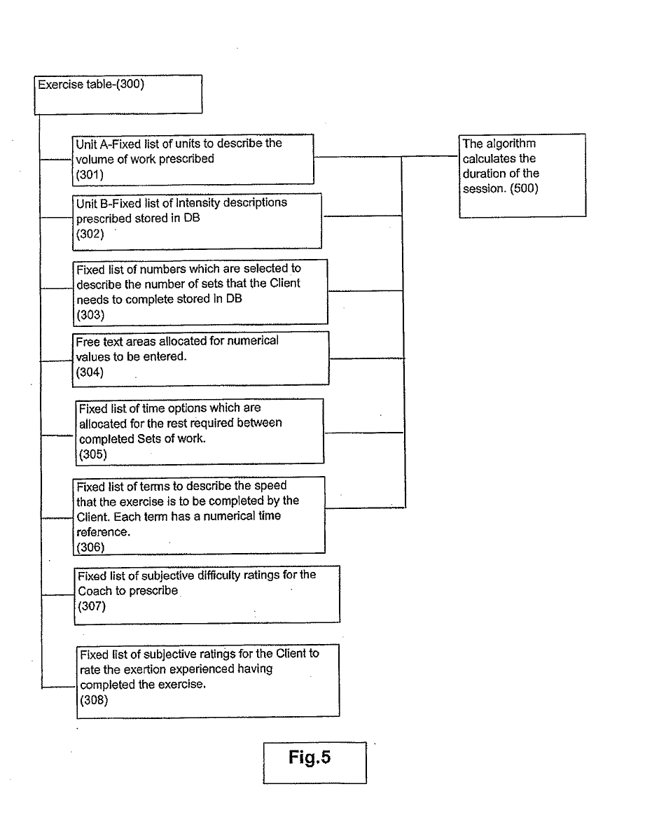

FIG. 6 Illustrates the database which contains the terms which reflect the parameters relating to the pre-populated Exercise tables.

In FIG. 6:

600—represents a Database which is not accessed or written to by the user,

601—represents a table which contains a list of terms (data elements) which describe the intensity that the exercise is to be completed and is stored in the database 600. This list is extracted from 301 which is contained in the 300 table,

602—represents a table which contains a list of terms (data elements) which describe the physiological adaptation required and is stored in a database 600,

603—represents a table which contains a list of terms (data elements) to describe the method of achieving the physiological adaptation and is stored in 600, and

604—represents the exercise template which is being created. The elements from 601, 602 and 603 are linked to the template. The template is saved as a unique file with the associated links attached and is saved in database 600.

The invention contains a series of pre-populated Exercise tables which can be imported directly into one or many Exercise tables. (FIG. 6) The pre-populated data alleviates the need to enter all of the required information in every time the exercise workload is authored.

This aspect of the Invention contains three database elements (601, 602, and 603). 603 is the same list of intensity terms contained in the 302. The templates are created by selecting one term from each database elements (601, 602 and 603) and the table contents are filled out in table 604. The database elements are coded or tagged to the respective Exercise tables (604) and each table is saved as an individual file in the database and cannot be edited by the user.

This is provided as a consequence of the Exercise tables contained in the invention having numerous combinations which prescribe the volume and intensity of the required work for the respective exercises. This simplifies the variety and flexibility in compiling the prescribed work process which may be time consuming and furthermore, where there are circumstances when the same information, volume and intensity, of work need to be prescribed for numerous occasions, this feature can provide the information readily.

FIG. 7 illustrates a user interface and the user database according to one aspect of the invention. In FIG. 7:

700—represents the User Interface (UI),

701—represents the UI which displays the templates associated with the selected data elements,

702—represents the User database contains the files (705) which are coded with the new terms (data elements) that are created by the user, 703 and 704,

703—represents a table which contains the list of terms (data elements) which the user creates to describe the physiological adaptation required and is stored in the User database, 702,

704—represents a table which contains the list of terms (data elements) which the user creates to describe the method of achieving the physiological adaptation required and is stored in the User database, 702, and

705—represents the template created by the user and contains links from data elements 601, and either 602 or 703 and either 603 or 704, depending on whether the template needs to be coded with data elements from 600 only or a combination of data elements from 600 and 702.

The database structure enables the user to create their own templates (705) and terms. Clicking the New Term button enables the user to create unique terms to code to the templates. The new terms are stored in the respective tables (703 or 704) in the User database (702), however 602 cannot be edited. If a table is created which uses the new terms, (from 703 and 704), the terms selected, in addition to a term selected from 602, are linked to the new table. When a search is conducted, the recently created template (705) will be retrieved only when the term from 601 plus the new term from 703 and 704 are selected. The template displays the User Interface (700) and appears in a table form at 701.

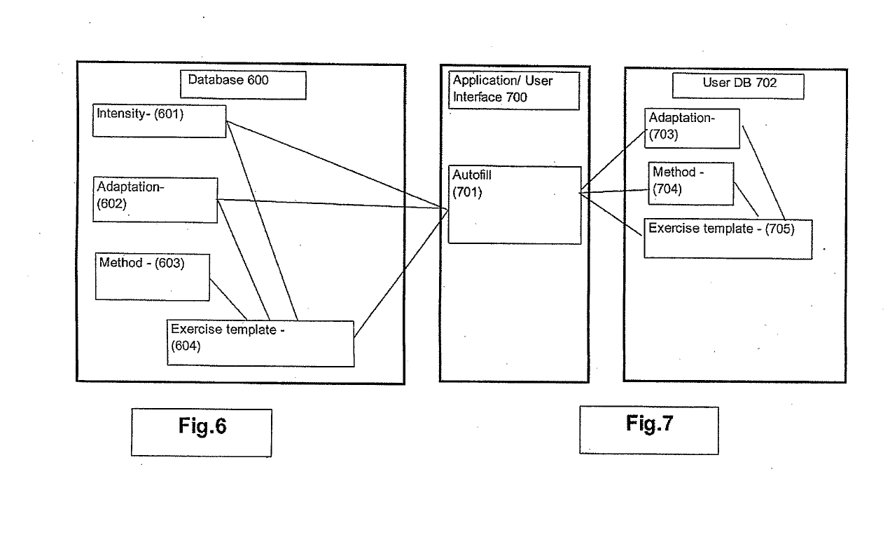

FIG. 8 illustrates a method of displaying and/or communicating the exercises according to one aspect of the invention. In FIG. 8:

800—represents the Exercise Object which is created as a result of extracting links that were generated at 100. The information that is extracted via the links to display the Exercise Object 800 are 801, 802, 803, 104 and 108,

801—represents a display of the photos that are linked to the exercises and are linked from 101,

802—represents a link to the movie file from 101 for the respective exercise,

803—represents the exercise name and number which is also the live link to a pop-up screen (More info). More info is created by extracting a series of links from 100,

804—represents a display of the difficulty level extracted from 104,

805—represents a display of the sketch from 108,

806—represents More Information which displays tips and cautions that are linked from 110, the photos file from 101,the movie file from 101, the difficulty level from 103, the sketch form 108, links to related exercises from 109 and links to More Info of the primary muscles involved 107,

807—represents the display of the tips and cautions from 110,

808—represents links to the database of related exercises which were established from 109,

809—represents a link to the databases (117) to the More Info (808) about the related exercises,

810—represents a display of more information of the muscle which contains textual information describing the anatomical characteristics of the muscle, a link to the synergists for the muscle (810) and two links to exercises which the muscle is used for,

811—represents the textual information about the characteristics of the muscle which include the origin, insertion, actions and innervation,

812—represents numerous links to the More Info screen of the synergists for the muscles listed (813),

813—represents the display of More info of synergist muscle from 812,

814—represents links to two exercises (More Info) that the muscle is used for, and

815—represents a display of more information of related exercise More Info from 814.

816—represents the image of the muscle relating to 810.

The invention contains an extensive database of exercises of which are displayed as an Exercise Object (800) in the application. Each Exercise Object has links to various forms of information which include a movie file (802), three stage photographs of the exercise (803), and an illustration of the body parts that the exercise focuses on (108).

The exercise name and number (803) is a live link to a pop-up page (More Info) which contains detailed textual information about the cautions that need to be taken into consideration while completing the exercise as Well as other tips and coaching cues, (806). The More Info also contains a link to a movie file (802), three stage photographs of the exercise (803), an illustration of the body parts that the exercise focuses on (108) and the difficulty level of the exercise (804). In addition, the More Info contains two further links to two related exercise and links to the muscles which are primarily used during the exercise.

Each of the More Info pages contain further related exercise links which enables the user to continue navigating the numerous pages of the related exercises.

The anatomy links on the Exercise More Info are live links to the pop-up page for the respective muscle 810 (Anatomy More info). These More Info pages contain a picture of the individual muscle (817), details about the anatomical characteristics of the muscle (811), the muscles synergists (812) and two further links to exercises which the muscles are used in (814). The synergist's link displays the More Info of the respective muscle and the related exercise link displays the More Info of the respective exercises. The More Info pages that are displayed offer a continuous display of additional information and access to numerous related exercises.

The Exercise Object contained in the invention provides numerous alternative forms of information to remind the Client how to perform the exercise and illustrates detailed information which cannot necessarily be seen with the naked eye. Having immediate access to all of the aforementioned information enhances the capabilities of the Client to not only remember the skill, but to also learn the skill completely based on the information provided.

The invention reduces the time that the Coach needs to spend teaching the Client how to perform the exercise and reduces the likelihood that the Client will forget how to complete the exercise.

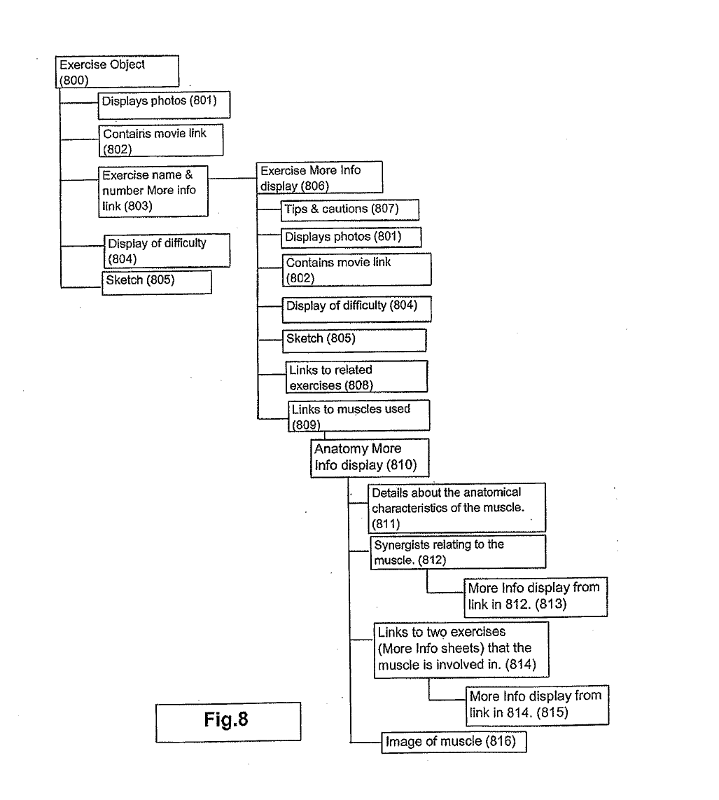

FIG. 9 illustrates the communication and exchanging of Exercise and Training programs according to an aspect of the invention. In FIG. 9:

900—represents a Coach who creates and sends the program using the Professional version of the application. The professional version contains the full functionality,

901—represents the Exercise program which contains the Exercise Object links, (800),

902—represents a Training program which contains substantially all of the Single Session text with their associated metadata links (1104),

903—represents a Client opening the file in the Client version of the application or the website. The Client version or website contains the restricted functionality,

904—represents the links associated with the Exercise Object contained in the files. The links 111, 112 and 101 plus content associated with Object table links 800 read to and then display the respective information accordingly,

905—is a representation of the Client database or website (1104) which is allocated for Single Session importation and includes the raw text, links to Exercise Object (800) and the associated GUID's (Globally Unique Identification number) with any new terms,

906—represents the links associated with the Exercise Object contained in the files. The links 111, 112 and 101 plus content associated with Object table links (800) read to and then display the respective information accordingly,

907—is a representation of the receiver's database (1104) which is allocated for Single Session importation and includes the raw text, links to Exercise Object (800) and the associated GUID's with any new terms, and

908—represents as the single session is saved, the GUID creates the new term to either database 1102 or 1103, depending on which database the new term was derived from. Therefore, the 1004 is also updated to enable the session to be tagged in the future with the new terms and 1005 is also updated in order for the new terms searched used to search in the future.

There are a number of benefits of using the links. Even though numerous numbers of programs are created, in some instances thousands of files will be saved onto the hard drive, this will not impact greatly on the memory and hard drive space of the user's computer. This is especially important given the amount of movie and photo files that are associated with the application and the fact that many Coaches use a laptop computer which may not have the same system specifications and hard drive space as the desk top computer. The small file sizes are unlikely to deter the Client from saving the programs onto the hard drive also.

A Client who travels frequently may take a laptop computer with them but may not have regular access to the internet. However, the small file sizes enable the user to visit an internet café or access the internet through other means and save the programs onto a disk. The file can then be opened onto the person's laptop from the disk without and concerns regarding file size.

The files attach very quickly to the emails and do not take long at all to send or to download. This is particularly important for people who have a slow dial up connection to the internet. Furthermore, the files that are attached to the emails which are stored on a server will not fill up the allocated email storage space. This is particularly important in circumstances where a Coach sends multiple programs but the Client is unable to access or download the files for whatever reasons.

The links associated with the Exercises ID's throughout the application results in the display of exercise objects being very fast. Exercise search returns, the incorporation of exercises into programs, copying and pasting functionality appear seamless which increases the speed that programs can be created and managed. Furthermore, the thought processes involved in creating the programs are not interrupted by delays or such events as loading the information, page scrolling and so on.

The navigation throughout the application is very speedy and does not place much stress in the users system. This enables the user to have multiple applications open at the same time while creating numerous programs and multi tasking. Consequently, the users can continue with all of the other work which is required without having to close the application.

In one embodiment, the invention is a stand alone system which eliminates the need for the Coach and the Client to log onto the internet to create or access the Exercise and Training programs.

The Coach uses a version of the application (900) which contains all of the functionality required to create the programs and email them accordingly. The Client needs to obtain a (903) which contains exactly the same raw database structures and content. In effect, the Client can open, view, print and enter the results back into the program then send the program back to the Coach.

When the Exercise programs are emailed to the Client, only the Exercise ID's (exercise numbers) are attached in the file in addition to any other text associated with the program. When the file is opened, the links associated with the Exercise ID (102) are directed to the relevant databases in the Client's software and retrieves and displays the matching data from respective databases in the Client's application (904).

When the Training programs are emailed, text associated with the sessions and the metadata elements tagged to the Single Sessions attached in the file. When the file is opened, the sessions are imported directly into the Clients database with the text and any exercise links associated with the exercises. The exercise links embedded in the single session are linked to the same database that the Exercise ID's read to and all of the metadata elements associated with the Single Session plus the GUID's remain linked to the single session (905). All of the files that are emailed are automatically compressed to decrease the file sizes further.

When the Training programs or Single Sessions are emailed from one Coach to another Coach, or to a user with the full functionality software, (906), the file from the email and can either import the sessions directly into their database or peruse through the sessions and import the Single Sessions individually.

The Single Sessions contain the raw text, any links to Exercise ID's and all of the associated metadata elements (908). If a Single Session contains a different term (new metadata element created by the sender), the GUIDs associated with the term and Single Session automatically creates the new term and updates the receivers databases (1102 and 1103), search display page (1005) and Single Session Editor page (1004). This ensures that all of the Single Sessions and the associated terms remain unique and that the sessions remain completely exchangeable.

As the Single Session is saved, the GUID creates the new term to either database 1 102 or 1103, depending on which database the new term was derived from. Therefore, the 1004 is also updated to enable the session to be tagged in the future with the new terms and 1005 is also updated in order for the new terms searched used to search.

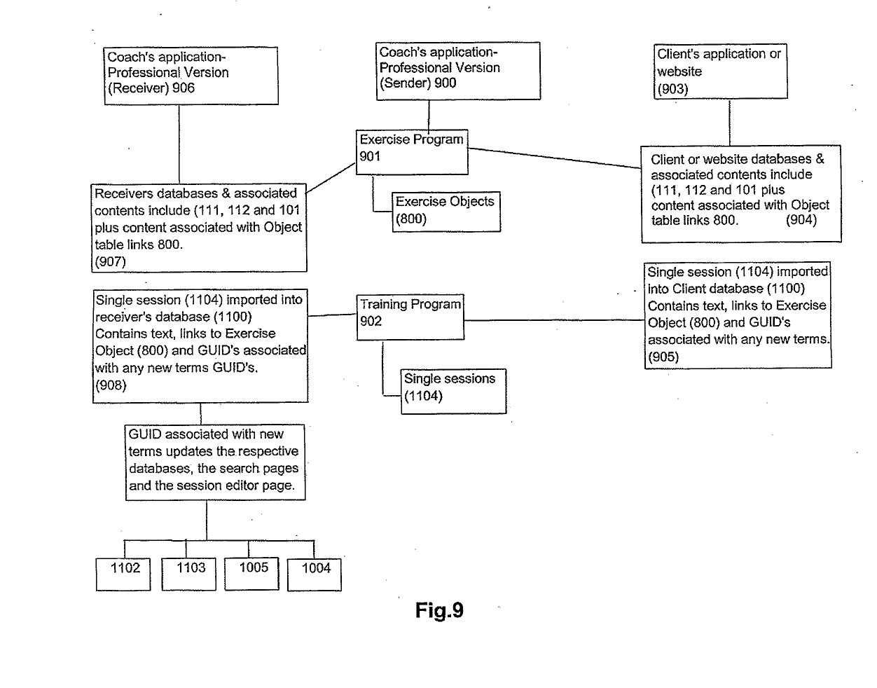

FIG. 10 illustrates a database and application interface used with a system according to one aspect of the invention. In FIG. 10:

1000—represents a database contained in application which the user cannot write to or edit and contains the fixed terms of metadata elements 1001,

1001—represents the fixed terms of metadata elements which are used to code the Single Sessions,

1002—represents the User Interface displays the Single Session created (1003), displays all of the metadata elements used to code the Single Session (1004) and displays the search results from a Single Session search (1006) which are displayed as per 114,

1003—represents the Single Session that is authored with free text and may contain exercise links in the body of the Single Session,

1004—represents the Single Session Editor which contains the same metadata elements as the Single Session search page (114). The Single Sessions are coded with these metadata elements and a GUID is allocated to each Single Session,

1005—represents a search being conducted by selecting the metadata elements from 114, and

1006—represents the search return of the Single Sessions which match the selections made from process 1005 and are displayed on 114.

Training sessions that are authored with free text (1000) are able to be coded with metadata elements appropriate to the respective training session (1004) and saved into a database (1104). The user can search for the specific sessions (1004) and import them directly into a Training program.

To save the files, the session editor (1001) is opened which contains a list of the same metadata elements as the Single Session search page (1004). The metadata elements are selected which correspond with the components of the exercise and are subsequently tagged to the session.

When a Single Session search is conducted and metadata elements are selected (1005), the sessions which contain the respective metadata elements retrieved from the database (1104) and are listed (1006).

The listed sessions can be imported directly into the Training program which eliminates the process of having to type every training session from scratch. The Single Session database grows according to the number of Single Sessions created or imported by the Coach. Over time, the database may become so extensive that all of the Training programs are created simply by importing the pre-authored Single Sessions. This inventive step saves significant time and reduces the intellectual processes required to create a Training program.

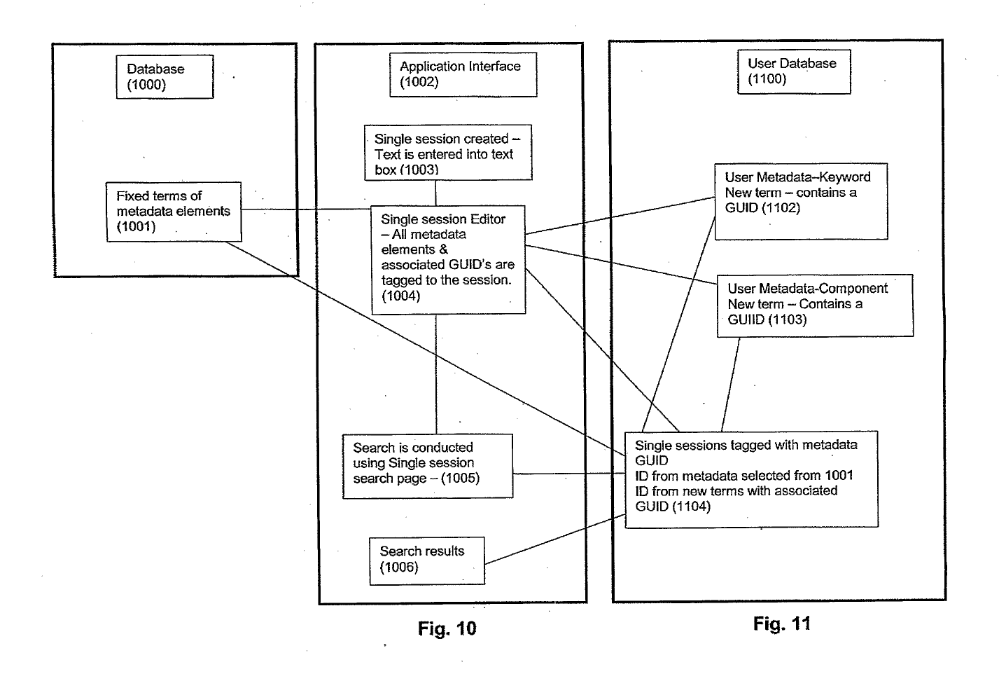

FIG. 11 illustrates user database used with a system according to one aspect of the invention. In FIG. 11:

1100—represents the database which contains the metadata elements created by the user. The items that are able to be added to are 1101 and 1102 only. The other metadata elements that are used to tag the Single Sessions are from 1001 and cannot be added to or edited,

1101—shows a representation of one of the tables in the user database which contains the metadata elements that are created by the user. A unique GUID is allocated to the all of the new metadata elements to ensure that all of the elements created remain unique,

1102—shows a representation of one of the other tables in the user database which contains the metadata elements that are created by the user. A unique GUID is allocated to the all of the new metadata elements to ensure that all of the elements created remain unique, and

1103—shows a representation of the newly tagged Single Session (a development of 1003) which contains the GUID's from 1102 and 1104.

The invention enables the user to create customised lists of metadata elements specific to the respective industry.

The requirements of Coaches and Clients can be very individual and specific to the various sports and activities in which the parties are involved. The Invention contains common exercise and physiological metadata elements but it cannot cater for all of the terminology and intricacies of every sport, exercise or human movement term.

The organisation of specific tables in the user database enables new metadata terms to be created and integrated into the Single Session search page (1005) and into the Single Session Editor (1004). The New term button is selected and the term is created and saved to the additional tables (either 1102 or 1103). A GUID is associated with each of the new terms and is subsequently tagged to the sessions which are coded with the new metadata terms.

The Single Sessions can be tagged with any number of combinations using one metadata element only or a combination of metadata elements.

This GUID associating the sessions which are tagged with new metadata elements enables the Single Sessions to be to be tagged and subsequently searched for. As previously mentioned the association of the GUID to the newly created terms enables the Single Sessions to be emailed to other users and imported directly into the database. The GUID automatically updates the search page (1005) and the Single Session Editor (1004) with the new terms in order for the sessions to be edited further and searched for. This functionality provides the capability to tag every session with customised metadata elements which cater for every exercise industry.

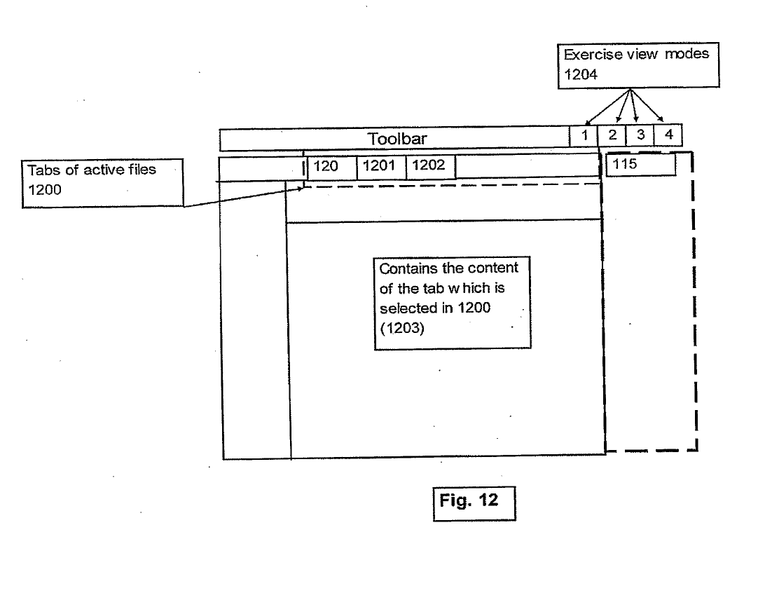

FIG. 12 illustrates the user interface according to one aspect of the invention. In FIG. 12:

1200—represents the areas on the user interface which contain the various tabs associated with the various files,

1201—represents an example of the tab of a file contained in 1200,

1202—represents an example of the tab of a file contained in 1200,

1203—represents the area in which the information associated with the various files is displayed. The content displayed in 1203 varies depending on the file tab selected in 1200, and

1204—represents the four display modes available for customising the appearance of the exercises in the Exercise program (1307).

The invention is designed to create numerous forms of files . . . . In addition to these files, the search page (113) is continuously accessed in order to create many of these files. Furthermore, it is likely that the files will be open and accessed simultaneously during the creation of the various forms of files. Having to maximise or minimise the display of the each of the respective files which are open on the users system may physically slow down the process of creating the files and distracts the user from the mental processes involved.

When the numerous individual files are opened using the current art, the unused files are minimised on the tool bar and are required to be maximised in order to view the files. This process requires the cursor to travel in a vertical position down the page to the to the tool bar to select the required file. This process requires two mouse clicks and which in addition to scrolling vertically down the page increases the time required to view the required files. As soon as the file is selected, the cursor then needs to be taken vertically up the page to where the control functions are to execute the required actions. This process takes time and further intellectual processes in order to display one of the many files that may be open and active.

In this aspect of invention, the invention user interface (FIG. 12) has incorporated an efficient method of navigating between the various files that are open in the application. The search page (120) and the files which are open (1201 as 1202) are placed in a tab format towards the top of the screen (1200).

For the purpose of this example, Tab 113 in 1200 represents the search page tab; tabs 1208 and 1209 represent other files which are active in the application in this schematic. The display of 1203 varies depending on the tab that is selected in 1200. If 120 (the search page) is selected, it displays in 1203, however the search results (114 and 115) remain displayed in the right pane also. If 1201 or 1202 are selected, the respective files will appear in 1203 and 114 and 115 will continue to remain displayed also.

Advantageously, by keeping the search results pane in full view, the exercises can be accessed at all times which is particularly important when numerous programs are being create at the same time. There is no need to have to open a file or switch unnecessarily to another screen in order to navigate between various files which are open which saves time and effort.

As the various tabs are selected, the only area on the screen which changes is 1201. The other user interface content remains fixed which is particularly important when numerous files are opened and accessed quickly and frequently.

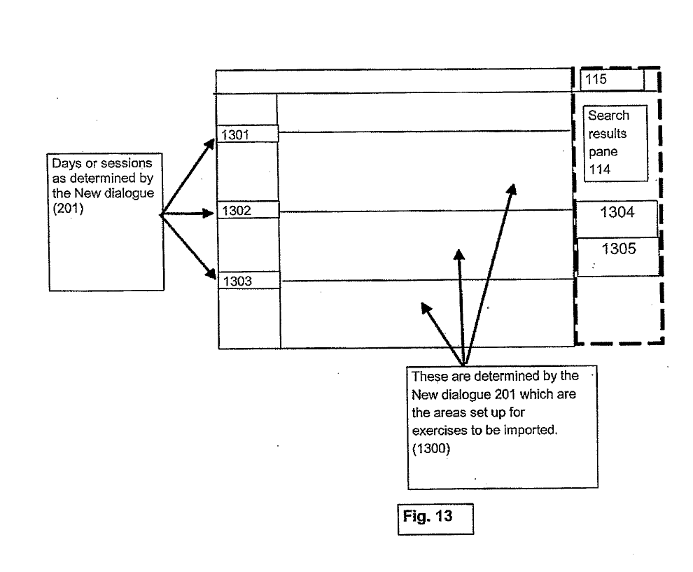

FIG. 13 illustrates the user interface relating to importing exercises or sessions into a program. In FIG. 13:

1300—represents the areas in the user interface which have been made available to receive exercises. These areas are referred to as slots and the positions of the slots are determined during the selection of the Exercise programs or Training programs in the New Dialogue (201),

1301—represents an example of a day or session contained in the template,

1302—represents an example of a day or session contained in the template,

1303—represents an example of a day or session contained in the template,

1305—represents an exercise which is imported into the exercise slot (1300) for the purpose of the examples, and

1306—represents an exercise which is imported into the exercise slot (1300) for the purpose of the examples,

When the Exercise template is selected from the New Dialogue (201) the structure of the template is created accordingly with empty slots contained throughout the template for the exercises to be entered into (1300). For example, 1301, 1302 and 1303 represent different sessions according to the dialogue settings selected. 1300 illustrates the areas in the user interface in which the exercises are imported into the program. These are “vacant spaces” and for the purpose of this description, they are referred to as slots.

There are numerous methods of entered the exercises into the programs (slots). The exercises (1304 and 1305) are either dragged and dropped from 114 into the available slots (1300) or the exercises can be double clicked and imported directly into the slots. Multiple exercises can be selected and imported into the exercise template via the shift or control functions which are available.

The inventors have realised that there are numerous occasions when the user will know the exact exercise he/she requires and the days in which the exercises need to be imported into. In order to import the same exercises into the various days using the aforementioned process, each exercise must be dragged and dropped into all of the respective days. This can be a lengthy process and may become frustrating, especially when the required contents of the program are known from the beginning.

In the Advanced Exercise program template contained in this aspect of Invention, the user can select and highlight one or more sessions, days or weeks which are situated in the left pane (1301, 1302 and 1303) of the user interface. Selecting these items determines the location that the exercises selected will be imported into. The exercises are then double clicked or dragged and dropped as previously mentioned to any one of the available slots of one of the corresponding sessions, (1300). The respective exercises are then imported into all of the highlighted session slots simultaneously. This functionality occurs for any week, session or days which are highlighted.

This functionality saves significant time during the construction of an Exercise program. In situations where the user knows the exercises which they want as well as the days that they want the exercises to be imported into, the aforementioned functionality significantly speeds up the process. Once the days or sessions are selected, the user simply has to either double click the exercise or drag and drop the exercises into the slots. There is no need to be precise with the drag and drop process because the exercises can be imported into any of the available slots which have been highlighted. This functionality eliminates the need for the user to take his/her eyes away from the search results screen which speeds up the importation process and reduces the intellectual processes required.

When exercises are entered into the available slots, they take a copy of the Exercise ID (exercise number) with it and place it in the slot. The Exercise ID is referenced to the tables 111, 112 and 119 in the Application Database and the images folder (101) and constructs the Exercise Object based on the links associated with the Exercise ID. The Exercise Element is the made up of the Exercise Object (800) and the Exercise Table (300) and displays in the respective programs. In memory, the Exercise ID has a link to the images (101) and draws the image in the Exercise Object. This is repeated wherever the exercise may be imported into the program. Information entered into the Exercise table is stored with the Exercise Element and is associated with the Exercise Element from hereon in.

The inventors also realise that the Exercise Elements which are displayed in the Advanced Strength program template take up reasonable vertical real estate in FIG. 13. This increases the vertical scrolling which is required to view all of the exercises which make up the program. Furthermore, with the detailed information associated with the Exercise table (300) perusing through the Exercise programs, especially the programs which contain numerous exercises, may be taxing on the eyes.

Another aspect of invention enables the user to customise the way in which the Exercise Elements display in the Advanced Exercise program. The Exercises Elements have four display modes which are; 1) the Exercise Object (800) and the Exercise table (300), 2) the Exercise name (106) and the Exercise table; 3) the Exercise name and the Exercise Object; 4) and the Exercise name only. The customisation functionality can be applied to an individual exercise or the customised display can be selected to become the default view for the users.

The invention enables the user to set their preferred display of the exercises by a toolbar function in the application. The Program tab in the Options function presents the various display modes available. By selecting the modes contained in the Program tab, all of the exercises which are imported into the programs will display according to the mode selected.

Advantageously, the various display modes which are offered require less vertical real-estate and are particularly useful in circumstances when the components and/or the Exercise Object or the Exercise table are not required. Ultimately, this enables more exercises to be viewed on the screen without needing to scroll. Furthermore, removing the Exercise table reduces the demand on the eyes while perusing through the content in the various programs. By providing the user with the capability to customise the default display enables them to view the exercises in the Advanced Strength program in their preferred format.

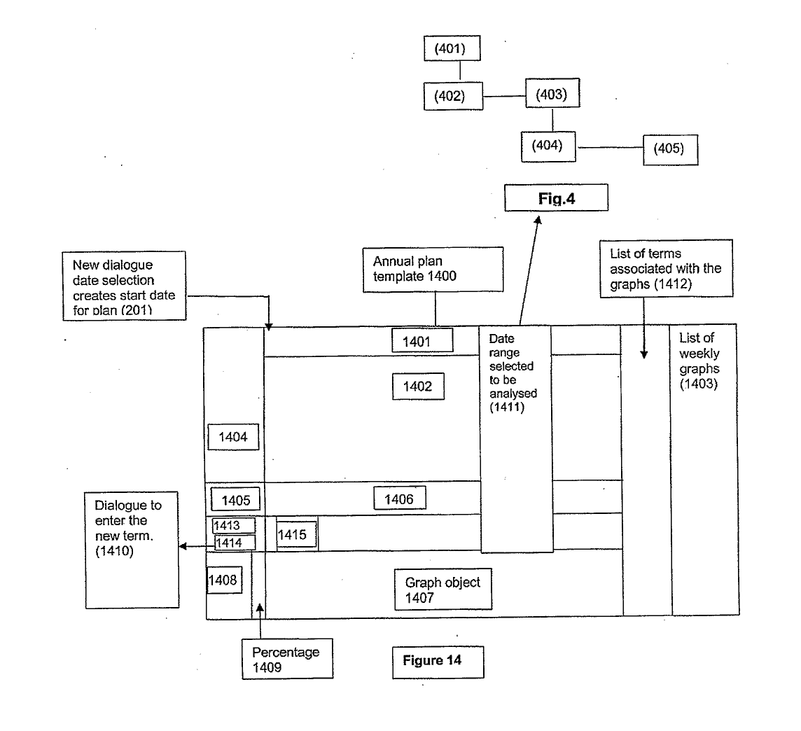

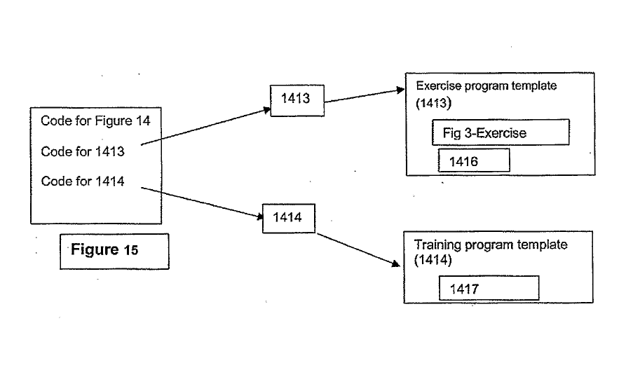

FIG. 14 illustrates the user interface relating to the functionality associated with the Annual Plan according to an aspect of the invention. FIG. 15 illustrates an Annual plan of which the Training program and Exercise program is embedded.

In FIGS. 14 and 15:

1400—represents all of general template associated with the Annual Plan,

1401—represents the list of dates corresponding to each of the weeks, The date is determined by the New Dialogue (201) and the subsequent dates are automatically generated,

1402—represents the data field in which the plan is organised into various phases. The contents of the Annual Plan are commonly known in this industry.

1403—represents a series of graph which are listed down the screen. Each graph is divided into the days of the week for the respective week in the Annual Plan.

1404—represents the fixed terms which are associated to the rows in the data field (1402) and are common terms in the industry. These terms cannot be edited by the user.

1405—represents the terms in which the user can create and input into the database. Each of the new terms can be associated with a unique graph for each term.

1406—represents the data field allocated to the new terms that are create by the user. As the new term is created, the rows are created to enable the user to enter the relevant information.

1407—represents the Annual graph which encompasses the plan in general terms. The graph (1407) provides a general overview of the Annual Plan and the terms associated with the graph can be edited (1408).

1408—represents the terms associated with the graphs that are displayed in 1407. These terms can be edited by the user at any stage.

1409—represents the intensity scale which the graphs make reference to when the respective cells are clicked. The vertical position that the cells are clicked corresponds with the percentage range illustrated in 1409.

1410—represents the dialogue box in which the new terms are entered and stored. The dialogue is stored in a table format in the User database (1100).

1411—represents the date range selected for the Exercise or Training program to be analysed.

1412—represents the terms associated with the list of weekly graphs. These terms are able to be edited by the user.

1413—represents the Exercise program associated with the Annual Plan.

1414—represents the Training program associated with the Annual Plan.

1415—represents the number of weeks selected for the template of the Exercise program and Training program.

1416—represents the Training Diary data entry dialogue in the Exercise Program.

1417—represents the Training Diary data entry dialogue in the Training Program.

In according to this aspect of the invention, there is a need to provide an effective way to display some of the required components in the Annual Plan in a graphical and tabular format. However the creation of the various graphs and tables is time consuming and requires significant technical skills in spreadsheet, database software applications.

Whereas, many of the Annual Plans created by Coaches are either hand drawn or created in other spreadsheet and word processing applications. However, hand drawn Annual Plans cannot be adjusted or modified very easily. If contents of the Annual Plan need to be moved or erased, the Annual Plan can become quite messy and disfigured. Furthermore, the hand drawn Annual Plans need to be physically filed away which has a high likelihood of being lost of misplaced, Spreadsheet, word processing and database software applications contain enormous detailed functionality. In most cases, such applications contain more functionality than what is required in order to construct Annual Plans and to create the plans using these methods requires reasonable computer skills. The formatting and manipulation of the various templates in other art are not specifically designed for creating Annual Plans and related illustrations. Furthermore, in order to generate useful graphical illustrations which provide an overview of the various components of training, a comprehensive knowledge of the software is required.

The invention enables the user to create individualised Annual Plans of which to produce graphs and to enter the required information. The user selects the New button (200), then selects the Annual Plan on the dialogue (201) and finally by selects the starting date from the dialogue (202). The dates associated with the rest of the weeks in the plan are automatically listed in the date cells for the respective weeks (1401).

The Annual Plan is divided into the 52 weeks by columns associated with each of the weeks. The Annual Plan contains common industry terms which are illustrated in 1404 and cannot be edited by the user. Each term (1404) divides the plan into horizontal rows across the screen. The junction between the rows and the columns creates numerous cells which are contained in the data field (1402), The data field is a functional area in which the users enter the required information such notes and headings and so forth for the respective terms (1404) and in reference to the dates for the particular weeks. These elements are the essence of the Annual Plan.

The invention enables the user to create numerous graphs. The first graph object represents the entire training year which divided into 52 weeks and is defined as the graph field (1407), The graph field is divided vertically and horizontally in the same manner as the data field. The graph contains numerous industry terms (1408) which define the respective rows. These terms differ to the terms listed in 1404 in that they are able to be edited by the user.

The centre of each cell in the graph field contains a vertical reference point which correlates to a percentage (1409). To create the required graph, the term (1408) is selected and the cursor is placed in line with the required percentage and the mouse is clicked. When the required percentage of the next cell or week is selected, the invention joins the two points and creates a line. This process is repeated for the entire year horizontally across the graph.

The other form of graph represents the days of the respective weeks and is listed down the page (1403). The graphs contained in 1403 contain the same action functionality but are representative of the days of the weeks rather than the weeks of the year.

Advantageously, determining the date from the dialogue alleviates the need to manually enter the graphs for each week or refer to calendars and the like. This preliminary step saves time and ensures that the dates associated with the Annual Plan are accurate.

The formatting capabilities of the data fields in the Annual Plan are simplified compared to previous art. The complicated functionality associated with other art is not incorporated in the invention and therefore is not overwhelming and does not require significant skills to use the features associated with the invention.

The process in which the graphs are created is simple and very accurate. The invention eliminates the need to create macros of other formula based systems in order to create the desired graphs. The single click or dragging functionality is quick and easy to use.

In one embodiment, the invention provides two forms of graphs whereby the first graph options display an overview of the training year whereas the second list of graphs provide the functionality to be more specific with the planning on a week to week basis. The combination of these graphs into the Annual Plan provides the user with the necessary information to design individualised Annual Plans in general terms and in specific detail.

As previously mentioned throughout this specification, the terms and components which make up the exercise and related industries vary significantly.

The invention enables the user to input their own terms and subsequently create their own graphs (1405), The field associated with 1405 is right clicked and a dialogue opens (1410). The required term is simply entered into the dialogue which stores the term in the Application. The new terms are listed in 1405 and if these terms are clicked and selected, a graph is created in 1407 for that term. The graph which is created contains the same functionality as the previously mentioned graphs.

With regard to the series of graphs in 1403 is that there are 52 series of graphs listed vertically down the screen. In order to enter the required data into the latter weeks in the year, the user has to scroll down the page. This could be a time consuming and cumbersome process.

The invention has linked the list of graphs is 1403 with the corresponding week numbers in 1402. As the required week number is selected, the corresponding graph is displayed at the top of 1403.

This preliminary step eliminates the need to scroll vertically to find the required graph. Furthermore, as the week is selected, the Coach can also view all of the other components which are relevant during the same period of the year as the selected week which is particularly important because this information may affect the way in which the graphs are illustrated. For example, if week 45 is selected, the entire column associated with that week is highlighted vertically down the data filed (1402) and the information displayed in the weeks leading up to and following week 45 can be viewed quickly. Therefore, the Coach does not have to constantly scan across the data fields and try to locate the corresponding weeks in reference to the graphs being created.

The analytical capabilities of the invention enable the user to select the date range of which the required analysis needs to take place (402). However, it is difficult to comprehend how the programs being analysed fit into the scheme of the training year. It is difficult to analyse a particular training phase based purely on the date selections such as those available in 402.

The invention allows the Exercise and Training programs to be analysed via the Annual Plan (1400). The week, selection of weeks, month or selection of months are selected by clicking the start date in the 1401 and the cursor is dragged across the screen to highlight the weeks which are required to be analysed. When the date range is highlighted to be analysed, the user selects whether the Exercise or Training program is required to be analysed and the selected program is analysed accordingly.

Having the capability of selecting the date ranges of which to analyse the Exercise or Training programs from the Annual Plan negates the need to open the analysis component of the invention (FIG. 400). Furthermore, since the content of the Exercise and Training programs is governed by the Annual Plan, the user can see all of the components that make up the training year and analyse the respective components directly from the plan without having to open another file or change the screen display.

Furthermore, Exercise programs and Training programs can be created directly from the Annual Plan. Once the Annual Plan is created via the New dialogue (FIG. 2) the template is created with reference to the date that was selected from the dialogue (202). To create a new Exercise or Training program into the Annual Plan a right click action made at (1405) and “New” is selected. This action either imports an existing Client or provides the functionality to create a new Client. Once selected, the Client's name is situated at 1405. Two rows are produced, one for the Exercise program (1413) and the other row for the Training program (1414).

To create a new Exercise or Training program, the action, for example, of pressing the ctrl and dragging the cursor along the row for the respective program is undertaken (1415). For every week that the cursor is dragged (which is determined by the fixed dates at 1401), the invention will create the template for that length of time. When the number of weeks for the program is determined, the left mouse button is clicked to create respective program for that period. For example, if 1415 is dragged out and selected at four weeks, the template for a four week Exercise program (1413) will be created.

In effect, the Annual Plan (FIG. 15 which is a simplistic overview of FIG. 14) is one file which contains the code to create the Annual Plan (FIG. 14), an Exercise program (1413) and the Training program (1414). Therefore, when the Exercise and Training programs are created within the Annual Plan, they are still shelled within the same program file (FIG. 14.1).

Ultimately, FIG. 15 is created, saved and communicated from the Coach to the Client with all, or substantially all of the programs contained in the individual file.

Within this aspect of invention, the components that are used for the collection of Training Diary data (1416) are contained in the same file as the Exercise program (1413) and Training program (1414) respectively. Advantageously, all of the steps are completed at the same time and into the same individual file.

For the Training program (1414), for example, the right mouse button is clicked on the individual training session (1417) and various menus present pre, defined terms for the recording of Training Diary data. For the Exercise program (1413) data is selected within the Exercise object (FIG. 3) and the via a right click function on the respective session, (1416). Consequently, substantially all of the data selected within the respective Programs remains within the Programs. Furthermore, the action of entering all of the Training Diary information is mouse driven with pre-defined terms to ensure consistency and continuity with respect to the future analysis.

In some circumstances the Training Diary information, Exercise programs and Training programs need to be analysed concurrently and independently. When the Exercise programs and Training programs are created within the Annual Plan (1413 & 1414), the Training Diary information, and various forms of Programs can be analysed concurrently and independently from the Annual Plan.

As in the inventive aspect 1400, the date range is selected for the Client being analysed and the data associated with that range is extrapolated and represented in graphical or tabular form.

This aspect of invention contains the functionality to create the Annual Plan, Exercise program and Training program and record Training Diary data in the same file and within the same software application. Therefore, to communicate all of the programs, only one file needs emailed to the end users, as long as they have a form of the software or access to the website.

The data associated with the programs, the Training Diary and the plan can be analysed and compared from one file. The invention does not rely on external software or specific websites to handle all of the data.

The creation of programs and plans is undertaken in the software application and is not reliant on a website. This negates the need to be online, which is more time efficient, and all of the information is stored on the hard drive or disk rather than a server. Alternatively, the data associated with the functionality of the Invention enables the Programs, Plans and Training Diary data to be uploaded to the website for storage and analysis.

This aspect of invention reduces the time required for the Coach to communicate the program to the Client and support staff. As a result of the time saving benefits of the invention, the Coach can either work with more Clients in order to increase business or have more spare time available.

The invention eliminates the reliance on other software applications and website subscriptions which can be costly.

The Programs can be viewed directly from the Annual Plan which saves time and intellectual energy. Advantageously, the invention eliminates the necessity of saving numerous files in the directory and then having to recall each of the file names of the respective files.

This aspect of invention does not require setting up macros or formulae to analyse the programs and training diary. The invention does not require technical know-how in order to create the required Plans or Programs. The templates and functionality are predefined and specifically designed for the creation and communication of various forms of programs and plans. Therefore the handling of the Programs, Training Diary information and Analysis is user-friendly and technically simple, eliminating the reliance of complicated formulae and macros.

This aspect of invention requires one file to be communicated to the Client rather than multiple files. Therefore, the Client handles all of the prescribed programs and information in a more manageable form. The management of all of the programs in one file decreases the potential for the programs to be misfiled amongst other files in the file directory.

The streamlined method of data collection improves the efficiency in which the physical, physiological and psychological information is obtained by the user. Accordingly, the Client's adherence to the data entry process may result in obtaining more reliable and regular data. Furthermore, the invention decreases the number of steps required to compare the data between the Programs, Training Diary and the Plan.

The physical, physiological and psychological information associated with the completion of Programs and from the Training Diary data entry can indicate trends with regard to performance, fatigue and overtraining. Early recognition of symptoms overtraining is integral with regard to the prescription and modifications of Programs.

If the Annual Plan and Programs produce successful training results, the evidence of the successful programs is contained in one file. The Coach can therefore identify the key performance indicators for successful programs and ultimately sell the information commercially.

The Coach can analyse the Plans and previous Programs retrospectively and use the information to assist with the planning for years to come. Upon recognizing key performance indicators of previous training periods, the qualitative and quantitative data can be used to assist with the planning for future Programs.

Components of a comprehensive training regime include, but are not limited to, the Annual Plan, the Exercise programs, Training programs and physical, physiological and psychological feedback from the Client. The Annual Plan governs the detail that is required in the Exercise program and Training program. Therefore, the Coach regularly refers to the Plan in order to update and modify the Programs. Training Diary data, Program data and Annual Plan is often recorded and stored externally to each other in separate files or by using different software applications.

The handling of the individual files and numerous forms of software is a common practice in the development of the Programs, Plans and Training Diary data logs. The multiple components are often handled as separate files and may use various forms of software. In order to better manage and communicate the files, the invention produces and stores all of the information within one file.

This aspect of invention allows the Annual Plan, Exercise program, Training program and Training Diary data to be created, filed and emailed as one file. In effect, the invention eliminates the need to use multiple forms of software and numerous individual files for each component. Accordingly, the communication of each component is enhanced as one file is involved. By obtaining all of the information in one file, and within the same software application, the data associated with the Plan, Programs and Training Diary can be analysed simply and in a user-friendly manner.

Alternatively, the Exercise programs and Training programs associated with the Annual plans able to be communicated within the plan or externally to the Annual Plan. There are circumstances where the Coach creates the Annual Plan but does not wish for the Client/s to view the plan. When the Exercise and Training programs are emailed to the Client, the Client can fill the required information as an independent file without viewing the Plan.

The functionality of communicating the Annual Plan, Exercise programs and Training programs to the Client as one file extends to the website. The Annual Plan can be uploaded to the website with the Exercise programs and Training programs embedded within the same file. The Exercise and Training programs can be extracted from the Annual Plan so when the programs are completed as prescribed, all of the information inputted back into the programs by the Client is uploaded with the program to the website back into the Annual Plan.

While this invention has been described in connection with specific embodiments thereof, it will be understood that it is capable of further modification(s). This application is intended to cover any variations uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. Various modifications and equivalent arrangements are intended to be included within the spirit and scope of the invention and appended claims. Therefore, the specific embodiments are to be understood to be illustrative of the many ways in which the principles of the present invention may be practiced. In the following claims, means-plus-function clauses are intended to cover structures as performing the defined function and not only structural equivalents, but also equivalent structures. For example, although a nail and a screw may not be structural equivalents in that a nail employs a cylindrical surface to secure wooden parts together, whereas a screw employs a helical surface to secure wooden parts together, in the environment of fastening wooden parts, a nail and a screw are equivalent structures.

“Comprises/comprising” when used in this specification is taken to specify the presence of stated features, integers, steps or components but does not preclude the presence or addition of one or more other features, integers, steps, components or groups thereof.” Thus, unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”.

1. A method of communicating an exercise representation from a first client to a second client, the method comprises the steps of:
providing an information file,
communicating the information file from the first client to the second client,
the second client, upon receipt of the information file, creating the exercise representation with reference to a database.

2. A method as claimed in claim 1, wherein the database is provided in a computer.

3. A method as claimed in claim 1, wherein the data base is provided on a website.

4. A method as claimed in claim 1, where the database is provided to each of the first and second clients.

5. A method as claimed in claim 1, wherein the first client creates the information file with reference to the database.

6. A method as claimed in claim 1, wherein either the first and/or the second client has remote access to the database.

7. A method as claimed in claim 1, wherein the database has at least one exercise object stored therein.

8. A method as claimed in claim 7, wherein the exercise object comprises any one or any combination of:
information being displayed
an illustration of a photo of the exercise
a sketch
a difficulty level
a link to a movie file
text
tips
cautions
associated exercises
metadata elements
an identification number
attributes and/or characteristics of the exercise
a link to a further information page.

9. A method as claimed in claim 7, wherein the exercise object is associated with human body parts.

10. A method as claimed in claim 1, wherein one information file is communicated to the second client.

11. A method as claimed in claim 1, wherein the information file comprises at least one or any combination of:
exercise identification
one or more metadata link(s)
one or more exercise object link(s)
Annual Plan, Exercise program, Training program and Training Diary.

12. A method as claimed in claim 1, wherein when the information file comprises the Annual Plan, Exercise Program, Training program and Training Dairy, the second client, upon receipt of the information file, is adapted to review the exercise representation with reference to a database.

13. A method as claimed in claim 12, wherein the information file is one file.

14. A method as claimed in claim 1, wherein email is used as a part of the communication.

15. A method as claimed in claim 1, wherein the information file is obtained via a website.

16. A method as claimed in claim 1, wherein from the information file, any one or a combination of a Annual Plan, Exercise Program, Training program and Training Diary is created.

17. A method as claimed in claim 1, wherein the information file comprises any one or any combination of an Annual Plan, Exercise Program, Training program, Training Diary.

18. A method as claimed in claim 1, wherein the database contains raw data, media and/or textual information associated with an exercise.

19. A method as claimed in claim 1, wherein the database is stored on a device associated with either and/or both the first and second clients.

20. A method as claimed in claim 1, wherein either and/or both the first and the second client is a user, coach, device, network, system.

21. A method as claimed in claim 11 or 17, wherein in creating the exercise, a template is opened, the exercise identification is read to a corresponding table in the database via the link(s), and the relevant information is extracted and displayed in a user interface.

22. A method as claimed in claim 1, further comprising the exercise representation being displayed to a client.

23. An authoring tool adapted to be used in association with an exercise representation, comprising:
linking means adapted to identify a link(s) to information stored in the database and means adapted to create the link(s).

24. An authoring tool as claimed in claim 23, further comprising means to provide the link(s) to a memory or the database.

25. An authoring tool as claimed in claim 23, wherein the linking means is operatively associated with the database.

26. An authoring tool as claimed in claim 23, wherein the link(s) are used to form the exercise representation in association with the database.

27. An authoring tool as claimed in claim 25, wherein the database includes an exercise object.

28. An authoring tool as claimed in claim 27, wherein the exercise object is associated with human body parts.

29. An authoring tool as claimed in claim 23, wherein the link(s) comprises at least one or any combination of:
exercise identification
one or more metadata link(s)
one or more exercise object link(s).

30. A method of creating an exercise representation adapted, the method comprising the steps of:
providing an information file,
creating the exercise representation using the information file together with an exercise object.

31. A method as claimed in claim 30, wherein the exercise representation is pre-populated in order to create a template.

32. A method as claimed in claim 30, wherein the exercise object is associated with human body parts.

33. A method as claimed in claim 30, wherein the information file comprises at least one or any combination of:
exercise identification
one or more metadata link(s)
one or more exercise object link(s).

34. A method as claimed in claim 30, further comprising the step of:
storing the exercise representation.

35. A method as claimed in claim 34, wherein the exercise representation is stored on a user platform.

36. A method as claimed in claim 30, wherein the exercise representation is stored on a remote platform.

37. A method as claimed in claim 30 or 33, wherein the exercise object comprises any one or any combination of:
information being displayed
an illustration of a photo of the exercise
a sketch
a difficulty level
a link to a movie file
text
tips
cautions
associated exercises
metadata elements
an identification number
attributes and/or characteristics of the exercise
a link to a further information page.

38. A method as claimed in claim 1 or 30, further comprising the exercise representation being displayed to a client.

39. An exercise object table, comprising:
an exercise object based on an information file, and
an exercise record adapted to record predetermined information regarding the exercise and/or a client's performance of the exercise.

40. An exercise table as claimed in claim 39, wherein the exercise object comprises any one or any combination of:
information being displayed
an illustration of a photo of the exercise
a sketch
a difficulty level
a link to a movie file
text
tips
cautions
associated exercises
metadata elements
an identification number
attributes and/or characteristics of the exercise
a link to a further information page.

41. An information file comprising at least one or any combination of:
exercise identification
one or more metadata link(s)
one or more exercise object link(s) adapted to be operatively associated with an exercise object.

42. A method of configuring a template adapted to be used in the execution of an exercise routine, the method comprising the steps of:
providing a program dialogue adapted to enable user selected configuration of a template for use in the exercise routine,
selecting from the program dialogue a desired format for the template.

43. A method as claimed in claim 42, wherein the format includes any one or any combination of:
starting date
the number of weeks
the number of sessions each day that the exercise is to be completed.

44. A method of estimating the duration (T) of execution of an exercise routine performed by a user, the method comprising the steps of:
assessing an exercise table and determining T in accordance with the following formula:
T=(totalTime*set2+rest2*(set2−1))*set1+rest1*(set1−1).

45. A method of analysing data representative of an exercise routine performed by a user, the method comprising the steps of:
accessing the data representative of the exercise routine,
selecting a portion of the data to be analyzed, and
performing the analysis based on information resident in the exercise object table.

46. A method as claimed in claim 45, wherein the analysis is instead performed based on information associated with the training program or an exercise session.

47. A method as claimed in claim 45, wherein the analysis is performed based on an association with human body parts.

48. An apparatus adapted to provide an exercise for an exercise program, said apparatus comprising:
processor means adapted to operate in accordance with a predetermined instruction set, said apparatus, in conjunction with said instruction set, being adapted to perform the method as claimed in claim 1, 30. 42, or 45.

49. A computer program product including:
a computer usable medium having computer readable program code and computer readable system code embodied on said medium for cooperating with a data processing system, said computer program product including:
computer readable code within said computer usable medium for providing an exercise representation for an exercise program in accordance with the method as claimed in claim 1, 30, 42, or 45.

50.-53. (canceled)
